(19) United States
(12) Patent Application Publication
(10) Pub. No.: US 2024/0204171 A1
(43) Pub. Date: Jun. 20, 2024

(54) ELECTRODE COMPRISING CARBON NANOTUBES AND AROMATIC COMPOUNDS AND PROCESS OF PREPARATION THEREOF

(71) Applicant: YEDA RESEARCH AND DEVELOPMENT CO. LTD., Rehovot (IL)

(72) Inventors: Boris RYBTCHINSKI, Givaataim (IL); Aayan MAITY, Rehovot (IL); Haim WEISSMAN, Rehovot (IL); Michal LESKES, Rehovot (IL)

(73) Assignee: YEDA RESEARCH AND DEVELOPMENT CO. LTD., Rehovot (IL)

(21) Appl. No.: 18/444,698

(22) Filed: Feb. 18, 2024

Related U.S. Application Data
(63) Continuation-in-part of application No. 18/262,732, filed on Jan. 1, 0001.

(30) Foreign Application Priority Data
Feb. 3, 2021 (IL) 280607

(51) Int. Cl. H01M 4/36; H01M 4/02; H01M 4/04; H01M 4/505; H01M 4/525; H01M 4/583; H01M 4/66; H01M 10/0525

(52) U.S. Cl. CPC H01M 4/364; H01M 4/0435; H01M 4/505; H01M 4/525; H01M 4/583; H01M 4/661; H01M 10/0525; H01M 2004/027; H01M 2004/028

(57) ABSTRACT

Provided herein noncovalent hybrids comprising carbon nanotubes (CNTs) and aromatic compounds, composites based on them, process of preparation and uses thereof, e.g. as electrodes and in lithium-ion cells; wherein the hybrids possess superior mechanical and electrical properties.

### CROSS REFERENCE TO RELATED APPLICATIONS

This application is a Continuation in Part of U.S. application Ser. No. 18/262,732 filed Jul. 25, 2023, which is a National Phase Application of PCT International Application No. PCT/IL2022/050147, filed Feb. 3, 2022, which claims the benefit of IL Patent Application No. 280607, filed Feb. 3, 2021, which are all incorporated in their entirety herein by reference.

### FIELD OF THE INVENTION

This invention provides noncovalent hybrids comprising carbon nanotubes (CNTs) and aromatic compounds, composites based on them, process of preparation and uses thereof, e.g. as electrodes and in lithium-ion cells; wherein the hybrids possess superior mechanical and electrical properties and provide dispersible CNT hybrids in organic and aqueous solvents.

### BACKGROUND OF THE INVENTION

CNTs are used to produce high quality electrodes and can enhance properties of various materials (e.g. polymers).¹ CNTs, both multiwalled (MWCNTs) and single walled (SWCNTs) become readily available and inexpensive due to recent large-scale production. Yet, CNTs have a high tendency for bundling, which impedes their dispersion in liquid (solvents) and solid (polymer) media. This issue limits the ability to fabricate materials with improved properties conveniently and cost-efficiently. This issue is a central challenge in the field.²⁻⁶

In the past the inventors used perylene diimide derivatives for CNT dispersions in solution⁷⁻¹¹, however, dispersion at concentration above 0.2 g/l could not be obtained in neat water, and in most organic solvents.

There is a need for new preferred solvent dispersed CNTs to better use it in spray-coating, filtration, casting and bulk composite applications, and/or as electrodes or within the same; and in lithium-ion cells.

### REFERENCES

(1) De Volder, M. F. L.; Tawfick, S. H.; Baughman, R. H.; Hart, a. J. Carbon nanotubes: present and future commercial applications. Science (New York, N.Y.) 2013, 535-539.
(2) Ata, M. S.; Poon, R.; Syed, A. M.; Milne, J.; Zhitomirsky, I. New developments in non-covalent surface modification, dispersion and electrophoretic deposition of carbon nanotubes. Carbon 2018, 130, 584-598.
(3) Di Crescenzo, A.; Ettorre, V.; Fontana, A. Non-covalent and reversible functionalization of carbon nanotubes. Beilstein J Nanotechnol 2014, 5, 1675-1690.
(4) Kharissova, O. V.; Kharisov, B. I.; de Casas Ortiz, E. G. Dispersion of carbon nanotubes in water and non-aqueous solvents. RSC Advances 2013, 3, 24812-24852.
(5) Koh, B.; Kim, G.; Yoon, H. K.; Park, J. B.; Kopelman, R.; Cheng, W. Fluorophore and Dye-Assisted Dispersion of Carbon Nanotubes in Aqueous Solution. Langmuir 2012, 28, 11676-11686.
(6) Liang, L.; Xie, W.; Fang, S.; He, F.; Yin, B.; Tlili, C.; Wang, D.; Qiu, S.; Li, Q. High-efficiency dispersion and sorting of single-walled carbon nanotubes via non-covalent interactions. J Mater Chem C 2017, 5, 11339-11368.
(7) Eisenberg, O.; Algavi, Y. M.; Weissman, H.; Narevicius, J.; Rybtchinski, B.; Lahav, M.; Boom, M. E. Dual Function Metallo-Organic Assemblies for Electrochromic-Hybrid Supercapacitors. Advanced Materials Interfaces 2020, 7.
(8) Niazov-Elkan, A.; Weissman, H.; Dutta, S.; Cohen, S. R.; Iron, M. A.; Pinkas, I.; Bendikov, T.; Rybtchinski, B. Self-Assembled Hybrid Materials Based on Organic Nanocrystals and Carbon Nanotubes. Adv Mater 2018, 30.
(9) Siram, R. B. K.; Khenkin, M. V.; Niazov-Elkan, A.; K, M. A.; Weissman, H.; Katz, E. A.; Visoly-Fisher, I.; Rybtchinski, B. Hybrid organic nanocrystal/carbon nanotube film electrodes for air- and photo-stable perovskite photovoltaics. Nanoscale 2019, 11, 3733-3740.
10) Tsarfati, Y.; Strauss, V.; Kuhri, S.; Krieg, E.; Weissman, H.; Shimoni, E.; Baram, J.; Guldi, D. M.; Rybtchinski, B. Dispersing perylene diimide/SWCNT hybrids: structural insights at the molecular level and fabricating advanced materials. J Am Chem Soc 2015, 137, 7429-7440.
(11) Yanshyna, O.; Weissman, H.; Rybtchinski, B. Recyclable electrochemical supercapacitors based on carbon nanotubes and organic nanocrystals. Nanoscale 2020, 12, 8909-8914.

### SUMMARY OF THE INVENTION

In one embodiment, this invention provides an electrode comprising a noncovalent hybrid, wherein the hybrid comprises carbon nanotubes and anthraquinone or derivative thereof. In another embodiment, the electrode further comprises an active material. In some embodiments, the electrode optionally further comprises a binder and/or a charge collector. In one other embodiment, the anthraquinone derivative is alizarin. In yet one further embodiment, the electrode is an anode and the active material is an anode active material comprising graphite. In yet one further embodiment, the electrode is a cathode and the active material is a cathode active material comprising a lithium based material.

In one other embodiment, this invention provides a lithium-ion cell comprising an anode, a cathode, an electrolyte, and a separator wherein at least one of the anode and the cathode comprises a noncovalent hybrid and an active material, wherein the noncovalent hybrid comprises a carbon nanotube and anthraquinone or derivative thereof.

In one other embodiment, this invention provides a process of preparing the electrode provided herein.

In one further embodiment, this invention provides a noncovalent hybrid comprising a carbon nanotube (CNT) and at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein their salts thereof and their derivative thereof.

In some embodiments, provided herein a noncovalent hybrid consisting essentially of a single-walled carbon nanotube (CNT) and at least one aromatic compound, wherein the aromatic compound is selected from the group consisting of anthraquinone, acridine, caffeic acid, phenazine, thymolphthalein, aramid nanofiber, their salt thereof and their derivative thereof.

A noncovalent hybrid consisting essentially of a multi-walled carbon nanotube (CNT) and at least one aromatic compound, wherein the aromatic compound is selected from the group consisting of anthraquinone, caffeic acid, safranin, thymolphthalein, aramid nanofiber, their salt thereof and their derivative thereof.

In one embodiment, this invention provides a composite comprising a polymer and a noncovalent hybrid comprising a carbon nanotube (CNT) and at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber (ANF), their salts thereof and their derivative thereof, wherein the composite has improved mechanical and/or conductivity. In other embodiments, the carbon nanotube is a single-walled carbon nanotube. In other embodiments, the carbon nanotube is a multi-walled carbon nanotube.

In one embodiment, this invention provides a porous electrode for electrochemical application, comprising a noncovalent hybrid comprising a carbon nanotube (CNT) and at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber (ANF), their salts thereof and their derivative thereof. In other embodiments, the carbon nanotube is a single-walled carbon nanotube. In other embodiments, the carbon nanotube is a multi-walled carbon nanotube.

In one embodiment, this invention provides a stretchable, flexible and/or inflatable material comprising a noncovalent hybrid comprising a carbon nanotube (CNT) and at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber (ANF), their salts thereof and their derivative thereof, wherein the hybrid is conductive, and the conductivity is maintained upon stretching or inflation of the material. In other embodiments, the carbon nanotube is a single-walled carbon nanotube. In other embodiments, the carbon nanotube is a multi-walled carbon nanotube.

In one embodiment, this invention provides an EMI (electromagnetic interference) shielding and electromagnetic radiation absorbers comprising a noncovalent hybrid comprising a carbon nanotube (CNT) and at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber (ANF), their salts thereof and their derivative thereof, wherein the hybrid is conductive in the infrared and microwave ranges. In other embodiments, the carbon nanotube is a single-walled carbon nanotube. In other embodiments, the carbon nanotube is a multi-walled carbon nanotube.

In one embodiment, this invention provides a construction material comprising a noncovalent hybrid comprising a carbon nanotube (CNT) and at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber, their salts thereof and their derivative thereof, wherein the hybrid reinforces the construction material. In other embodiments, the carbon nanotube is a single-walled carbon nanotube. In other embodiments, the carbon nanotube is a multi-walled carbon nanotube.

In one embodiment, this invention provides a process for the preparation of a noncovalent hybrid comprising a carbon nanotube (CNT) and at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber, their salts thereof and their derivative thereof; wherein the process comprises:
optionally grinding the carbon nanotube; and
mixing the carbon nanotube and the at least one aromatic compound in a sonication bath in an aqueous solvent, an organic solvent, or combination thereof and sonicated for a period of time to obtain a dispersion comprising the hybrid.

### BRIEF DESCRIPTION OF THE FIGURES

The subject matter regarded as the present invention is particularly pointed out and distinctly claimed in the concluding portion of the specification. The present invention, however, both as to organization and method of operation, together with objects, features, and advantages thereof, may best be understood by reference to the following detailed description when read with the accompanying drawings in which:

FIGS. 1A-1C: (FIG. 1A) presents a SEM image of a polyethylene (PE) sheet covered from both sides with a SWCNT-alizarin hybrid as described in Example 2; (FIG. 1B) SEM image of the cross-section of the same sheet illustrating the double sided coating; (FIG. 1C) zoom-in on the area in the dashed-line rectangle in (FIG. 1B). Illustrating the PE-SWCNT-alizarin composite with a thickness of 93-103 μm and the layers of the SWCNT-alizarin hybrid with an average thickness of 10±3 μm.

FIGS. 2A-2E present a picture of dispersions in different organic solvents before and after bath sonication, demonstrating a more homogeneous dispersion and more stable, following the sonication step: (FIG. 2A) MWCNT in ACN, left blank and right with purpurin prior 15 min bath sonication; (FIGS. 2B-2E) MWCNT in different solvents, right blank and left with purpurin after 14 h after bath sonication (FIG. 2B) ACN; (FIG. 2C) acetone; (FIG. 2D) EA; (FIG. 2E) THF.

FIGS. 3A-3E present (FIG. 3A) a SEM image of a non-woven polypropylene (PP) sheet covered from one side with a SWCNT-alizarin hybrid; (FIG. 3B) SEM image of the cross-section of the same sheet illustrating also the coating of the internal PP fibers with up to several hundreds of nm of the SWCNT hybrid; (FIG. 3C) A zoom-in on a cross-sectioned PP fiber and its SWCNT hybrid coating; (FIG. 3D) A zoom-in on the area in the dashed-line rectangle in (FIG. 3C); (FIG. 3E) A zoom-in on the area in the dashed-line rectangle in FIG. 3D.

FIGS. 4A-4D present SEM images of NMC811 electrode of this invention, prepared from isopropanol. FIGS. 4A and 4B are images of the same area but with different acceleration voltages: 3 Kv (4A) and 20 Kv (4B). FIGS. 4C and 4D are zoomed-in images that illustrate the NMC811 (LiNi_{0.8}Co_{0.1}Mn_{0.1}O₂) and CNT interaction in the formed polymer-free and carbon black-free composite electrode.

FIG. 5A-5B present rate performance (FIG. 5A) and columbic efficiency (FIG. 5B) of various NMC811 (LiNi_{0.8}Co_{0.1}Mn_{0.1}O₂) cathodes of this invention vs. Li metal, both measured at varying C rates using 1M LP30 electrolyte (The discharge capacity is expressed in terms of capacity per gram of NMC811). In the legend: “NMC-CNT 1” and “NMC-CNT 2” denote different batches of the same sample, having about 12.7 mm diameter; bracketed mass and length (“um” is micron) are mass of batch and thickness thereof, respectively; and “IPA” and “acetone” are the solvents used to disperse the CNT/alizarin hybrid in order to prepare the electrodes.

FIG. 6 presents rate performance of various NMC811 (LiNi_{0.8}Co_{0.1}Mn_{0.1}O₂) cathodes of this invention vs. Li metal, both measured at varying C rates using 1M LP30 electrolyte (The discharge capacity is expressed in terms of capacity per surface area NMC811 electrode). In the legend: bracketed mass is mass of different batches of the same sample; and “IPA” and “acetone” are the solvents used to disperse the CNT/alizarin hybrid in order to prepare the electrodes.

FIG. 7 presents stability study of various NMC811 (LiNi_{0.8}Co_{0.1}Mn_{0.1}O₂) cathodes of this invention vs. Li metal at a 1 C rate using 1M LP30 electrolyte. The discharge capacity is expressed in terms of capacity per gram of NMC811. In the legend, “IPA” and “acetone” are the solvents used to disperse the CNT/alizarin hybrid in order to prepare the electrodes.

FIG. 8 presents a photo of a Graphite-CNT-alizarin electrode of this invention, 39 mm in diameter.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The superior mechanical and electrical properties of carbon nanotubes (CNTs) are uniquely advantageous for enhancing mechanical and electrical properties of composites (e.g. polymer/CNT ones) that have a broad applicability as electrodes, reinforced materials, antistatic/EMI shielding materials, and construction materials. Noncovalent molecular attachment to carbon nanotubes (CNTs) has become a preferred approach for overcoming the dominant tendency of CNTs for aggregation, without harming CNT mechanical and electrical properties (as typical of covalent modifications). This invention provides a hybrid of inexpensive aromatic molecules and CNTs which noncovalently modify CNTs for efficient and stable dispersions in a broad variety of solvents, solvent mixtures and polymers. The resulting CNT materials can be utilized for the fabrication of electrodes, sensors, and composites with improved mechanical and electrical properties.

### Noncovalent Hybrid

In some embodiments, the invention is directed to noncovalent hybrid comprising a carbon nanotube (CNT) and at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber, their salts thereof and their derivative thereof.

In some embodiments, the hybrid provided herein comprises a carbon nanotube (CNT) and anthraquinone, salt thereof or derivatives thereof. In another embodiment, the anthraquinone and derivative thereof is represented by the structure of formula I:

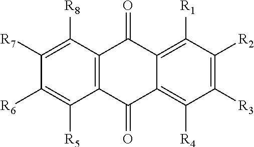

wherein each of R₁-R₈ is independently hydrogen, hydroxy, alkyl, alkenyl, halide, haloalkyl, CN, COOH, alkyl-COOH, alkylamine, amide, alkylamide, aryl, heteroaryl, cycloalkyl, heterocycloalkyl, thio (SH), thioalkyl, alkoxy, ether (alkyl-O-alkyl), OR⁹, COR⁹, COOCOR⁹, COOR⁹, OCOR⁹, OCONHR⁹, NHCOOR⁹, NHCONHR⁹, OCOOR⁹, CON(R⁹)₂, SR⁹, SO₂R⁹, SOR⁹, SO₂NH₂, SO₂NH(R⁹), SO₂N(R⁹)₂, NH₂, NH(R⁹), N(R⁹)₂, CONH₂, CONH(R⁹), CON(R⁹)₂, CO(N-heterocycle), NO₂, cyanate, isocyanate, thiocyanate, isothiocyanate, mesylate, tosylate or triflate; wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. Each represents a separate embodiment of this invention. In other embodiments, the carbon nanotube is a single-walled carbon nanotube.

In other embodiments, the carbon nanotube is a multi-walled carbon nanotube. In some embodiments, R₁, R₂, R₃, R₄, R₅, R₆, R₇ or R₈ of the structure of formula I is each independently a hydrogen. In some embodiments, R₁, R₂, R₃, R₄, R₅, R₆, R₇ or R₈ is each independently hydroxy. In some embodiments, R₁, R₂, R₃, R₄, R₅, R₆, R₇ or R₈ is each independently an alkyl. In some embodiments, R₁, R₂, R₃, R₄, R₅, R₆, R₇ or R₈ is each independently an alkenyl. In some embodiments, R₁, R₂, R₃, R₄, R₅, R₆, R₇ or R₈ is each independently a halide. In some embodiments, R₁, R₂, R₃, R₄, R₅, R₆, R₇ or R₈ is each independently a haloalkyl. In some embodiments, R₁, R₂, R₃, R₄, R₅, R₆, R₇ or R₈ is each independently a CN. In some embodiments, R₁, R₂, R₃, R₄, R₅, R₆, R₇ or R₈ is each independently a COOH. In some embodiments, R₁, R₂, R₃, R₄, R₅, R₆, R₇ or R₈ is each independently a alkyl-COOH. In some embodiments, R₁, R₂, R₃, R₄, R₅, R₆, R₇ or R₈ is each independently an alkylamine. In some embodiments, R₁, R₂, R₃, R₄, R₅, R₆, R₇ or R₈ is each independently an amide. In some embodiments, R₁, R₂, R₃, R₄, R₅, R₆, R₇ or R₈ is each independently an aryl. In some embodiments, R₁, R₂, R₃, R₄, R₅, R₆, R₇ or R₈ is each independently a heteroaryl. In some embodiments, R₁, R₂, R₃, R₄, R₅, R₆, R₇ or R₈ are each independently a cycloalkyl. In some embodiments, R₁, R₂, R₃, R₄, R₅, R₆, R₇ or R₈ is each independently a heterocycloalkyl. In some embodiments, R₁, R₂, R₃, R₄, R₅, R₆, R₇ or R₈ is each independently a haloalkyl. In some embodiments, R₁, R₂, R₃, R₄, R₅, R₆, R₇ or R₈ is each independently a thio (SH). In some embodiments, R₁, R₂, R₃, R₄, R₅, R₆, R₇ or R₈ is each independently a thioalkyl. In some embodiments, R₁, R₂, R₃, R₄, R₅, R₆, R₇ or R₈ is each independently an alkoxy. In some embodiments, R₁, R₂, R₃, R₄, R₅, R₆, R₇ or R₈ is each independently an ether (alkyl-O-alkyl). In some embodiments, R₁, R₂, R₃, R₄, R₅, R₆, R₇ or R₈ is each independently a OR⁹, wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₁, R₂, R₃, R₄, R₅, R₆, R₇ or R₈ are each independently a COR⁹, wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₁, R₂, R₃, R₄, R₅, R₆, R₇ or R₈ are each independently a COOCOR⁹, wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₁, R₂, R₃, R₄, R₅, R₆, R₇ or R₈ are each independently a COOR⁹, wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₁, R₂, R₃, R₄, R₅, R₆, R₇ or R₈ is each independently a OCOR⁹, wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₁, R₂, R₃, R₄, R₅, R₆, R₇ or R₈ is each independently a OCONHR⁹, wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₁, R₂, R₃, R₄, R₅, R₆, R₇ or R₈ is each independently a NHCOOR⁹, wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₁, R₂, R₃, R₄, R₅, R₆, R₇ or R₈ is each independently a NHCONHR⁹, wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₁, R₂, R₃, R₄, R₅, R₆, R₇ or R₈ is each independently a OCOOR⁹, wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₁, R₂, R₃, R₄, R₅, R₆, R₇ or R₈ is each independently a CON(R⁹)₂, wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₁, R₂, R₃, R₄, R₅, R₆, R₇ or R₈ is each independently a SR⁹, wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₁, R₂, R₃, R₄, R₅, R₆, R₇ or R₈ is each independently a SO₂R⁹, wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₁, R₂, R₃, R₄, R₅, R₆, R₇ or R₈ is each independently a SOR⁹, wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₁, R₂, R₃, R₄, R₅, R₆, R₇ or R₈ is each independently a SO₂NH₂. In some embodiments, R₁, R₂, R₃, R₄, R₅, R₆, R₇ or R₈ are each independently a SO₂NH(R⁹), wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₁, R₂, R₃, R₄, R₅, R₆, R₇ or R₈ is each independently a SO₂N(R⁹)₂, wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₁, R₂, R₃, R₄, R₅, R₆, R₇ or R₈ is each independently a NH₂. In some embodiments, R₁, R₂, R₃, R₄, R₅, R₆, R₇ or R₈ are each independently a NH(R⁹), wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₁, R₂, R₃, R₄, R₅, R₆, R₇ or R₈ are each independently a N(R⁹)₂, wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₁, R₂, R₃, R₄, R₅, R₆, R₇ or R₈ is each independently a CONH₂. In some embodiments, R₁, R₂, R₃, R₄, R₅, R₆, R₇ or R₈ is each independently a haloalkyl CONH(R⁹). In some embodiments, R₁, R₂, R₃, R₄, R₅, R₆, R₇ or R₈ is each independently a CON(R⁹)₂. In some embodiments, R₁, R₂, R₃, R₄, R₅, R₆, R₇ or R₈ is each independently a CO(N-heterocycle. In some embodiments, R₁, R₂, R₃, R₄, R₅, R₆, R₇ or R₈ is each independently a NO₂. In some embodiments, R₁, R₂, R₃, R₄, R₅, R₆, R₇ or R₈ is each independently a cyanate. In some embodiments, R₁, R₂, R₃, R₄, R₅, R₆, R₇ or R₈ is each independently an isocyanate. In some embodiments, R₁, R₂, R₃, R₄, R₅, R₆, R₇ or R₈ is each independently a thiocyanate. In some embodiments, R₁, R₂, R₃, R₄, R₅, R₆, R₇ or R₈ is each independently an isothiocyanate. In some embodiments, R₁, R₂, R₃, R₄, R₅, R₆, R₇ or R₈ is each independently a mesylate. In some embodiments, R₁, R₂, R₃, R₄, R₅, R₆, R₇ or R₈ is each independently a tosylate. In some embodiments, R₁, R₂, R₃, R₄, R₅, R₆, R₇ or R₈ is each independently a triflate. In some embodiments, R₁, R₂, R₃, R₄, R₅, R₆, R₇ or R₈ is not SO₂H.

In one embodiment, the hybrid provided herein comprises a carbon nanotube and an anthraquinone, salt thereof or derivative thereof. In one embodiment, the anthraquinone derivative is a dihydroxy or a trihydroxy anthraquinone. In another embodiment, the anthraquinone derivative is purpurin or alizarin. In other embodiments, the carbon nanotube is a single-walled carbon nanotube. In other embodiments, the carbon nanotube is a multi-walled carbon nanotube.

In some embodiments, the hybrid provided herein comprises a carbon nanotube and an acridine, salt thereof or derivatives thereof. In one embodiment, the acridine derivative is acridine orange. In other embodiments, the carbon nanotube is a single-walled carbon nanotube. In other embodiments, the carbon nanotube is a multi-walled carbon nanotube.

In some embodiments, the hybrid provided herein comprises a carbon nanotube and a naphthalene disulfonic acid, salt thereof or derivative thereof. In one embodiment, the naphthalene disulfonic acid derivative salt is selected from the group consisting of chromotropic acid disodium salt, 2,6-naphthalenedisulfonic acid sodium salt, 2,7-naphthalenedisulfonic acid sodium salt, 2-(4-nitrophenylazo)chromotropic acid disodium salt (Chromotrope 2B), tetrasodium 4-amino-5-hydroxy-3,6-bis[[4-[[2-(sulphonatooxy)ethyl]sulphonyl]phenyl]azo]naphthalene-2,7-disulphonate (Reactive Black 5), and any combination thereof. In other embodiments, the carbon nanotube is a single-walled carbon nanotube. In other embodiments, the carbon nanotube is a multi-walled carbon nanotube.

In some embodiments, the hybrid provided herein comprises a carbon nanotube and a caffeic acid, salt thereof or derivative thereof. In other embodiments, the caffeic acid derivative comprises a caffeic ester or a caffeic amide. In other embodiments, the carbon nanotube is a single-walled carbon nanotube. In other embodiments, the carbon nanotube is a multi-walled carbon nanotube.

In some embodiments, the hybrid provided herein comprises a carbon nanotube and a phenazine, salt thereof or derivative thereof. In other embodiments, the carbon nanotube is a single-walled carbon nanotube. In other embodiments, the carbon nanotube is a multi-walled carbon nanotube.

In some embodiments, the hybrid provided herein comprises a carbon nanotube and an indigo, salt thereof or derivative thereof. In another embodiment, the indigo derivative comprises indigo carmine. In other embodiments, the carbon nanotube is a single-walled carbon nanotube. In other embodiments, the carbon nanotube is a multi-walled carbon nanotube.

In some embodiments, the hybrid provided herein comprises a carbon nanotube and a rhodamine, salt thereof or derivative thereof. In another embodiment, the indigo derivative comprises rhodamine 101 inner salt. In other embodiments, the carbon nanotube is a single-walled carbon nanotube. In other embodiments, the carbon nanotube is a multi-walled carbon nanotube.

In some embodiments, the hybrid provided herein comprises a carbon nanotube and a phenothiazine, salt thereof or derivatives thereof. In another embodiment, the phenothiazine derivative comprises methylene blue. In other embodiments, the carbon nanotube is a single-walled carbon nanotube. In other embodiments, the carbon nanotube is a multi-walled carbon nanotube.

In some embodiments, the hybrid provided herein comprises a carbon nanotube and a thymolphthalein, salt thereof or derivatives thereof. In other embodiments, the carbon nanotube is a single-walled carbon nanotube. In other embodiments, the carbon nanotube is a multi-walled carbon nanotube.

In some embodiments, the hybrid provided herein comprises a carbon nanotube and an aramid nanofiber (ANF). Kevlar is a well-known ultrastrong para-aramid synthetic fiber with a high tensile strength-to weight ratio. The Kevlar fibers can be fragmented into low molecular weight chains and dissolved to form aramid nanofiber (ANF) solution, using DMSO and KOH as first shown by Kotov et al [Yang et al., “Dispersions of aramid nanofibers: A new nanoscale building block,” ACS Nano, vol. 5, no. 9, pp. 6945-6954, 2011]. In other embodiments, the carbon nanotube is a single-walled carbon nanotube. In other embodiments, the carbon nanotube is a multi-walled carbon nanotube.

In some embodiments ANF is added to SWCNTs dispersion following vacuum filtration to obtain SWCNTs-ANF hybrid with improved mechanical properties. In one embodiment, this invention provides a noncovalent hybrid comprising a carbon nanotube (CNT) and at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber (ANF) their salts thereof and their derivative thereof. In another embodiment, the hybrid comprises two, three, four or more different aromatic compounds within the hybrid.

In some embodiments the hybrid provided herein consists essentially of a CNT and an aromatic compound, salt thereof or derivative thereof. In some embodiments the hybrid provided herein consists essentially of a CNT and at least one aromatic compound, salt thereof or derivative thereof. In some embodiments the hybrid provided herein consists essentially of a CNT and at least one aromatic compound, salt thereof or derivative thereof, wherein the hybrid does not comprise a dispersant.

In some embodiments, provided herein a noncovalent hybrid consisting essentially of a single-walled carbon nanotube (CNT) and at least one aromatic compound, wherein the aromatic compound is selected from the group consisting of anthraquinone, acridine, caffeic acid, phenazine, thymolphthalein, aramid nanofiber (ANF), their salt thereof and their derivative thereof.

A noncovalent hybrid consisting essentially of a multi-walled carbon nanotube (CNT) and at least one aromatic compound, wherein the aromatic compound is selected from the group consisting of anthraquinone, caffeic acid, safranin, thymolphthalein, aramid nanofiber, their salt thereof and their derivative thereof.

In some embodiments, the hybrid provided herein comprises at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber (ANF) their salt thereof and their derivative thereof. In other embodiments, the term “derivative thereof” comprises a chemical modification of any one of the listed aromatic compounds with one or more functional groups or with any chemical group (i.e, hydroxyl, alkyl, aryl, halide, nitro, amine, ester, amide, carboxylic acid or combination thereof). For example, by derivatizing anthraquinone with hydroxyl groups (alizarin, purpurin) a hydrophilic hybrid is obtained. By derivatizing anthraquinone with hydrophobic groups (C₆-C₁₀alkyls), a hydrophobic hybrid is obtained.

In some embodiments, the hybrid provided herein comprises at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber (ANF) their salt thereof and their derivative thereof. In other embodiments, the salts of any one of the listed aromatic compounds is an organic or inorganic acid salt or an organic or inorganic basic salt.

Suitable acid salts comprising an inorganic acid or an organic acid. In one embodiment, examples of inorganic acid salts are bisulfates, borates, bromides, chlorides, hemisulfates, hydrobromates, hydrochlorates, 2-hydroxyethylsulfonates (hydroxyethanesulfonates), iodates, iodides, isothionates, nitrate, persulfates, phosphate, sulfates, sulfamates, sulfanilates, sulfonic acids (alkylsulfonates, arylsulfonates, halogen substituted alkylsulfonates, halogen substituted arylsulfonates), sulfonates and thiocyanates.

In one embodiment, examples of organic acid salts may be selected from aliphatic, cycloaliphatic, aromatic, araliphatic, heterocyclic, carboxylic and sulfonic classes of organic acids, examples of which are acetates, arginines, aspartates, ascorbates, adipates, anthranilate, algenate, alkane carboxylates, substituted alkane carboxylates, alginates, benzenesulfonates, benzoates, bisulfates, butyrates, bicarbonates, bitartrates, carboxilate, citrates, camphorates, camphorsulfonates, cyclohexylsulfamates, cyclopentanepropionates, calcium edetates, camsylates, carbonates, clavulanates, cinnamates, dicarboxylates, digluconates, dodecylsulfonates, dihydrochlorides, decanoates, enanthuates, ethanesulfonates, edetates, edisylates, estolates, esylates, fumarates, formates, fluorides, galacturonate gluconates, glutamates, glycolates, glucorate, glucoheptanoates, glycerophosphates, gluceptates, glycollylarsanilates, glutarates, glutamate, heptanoates, hexanoates, hydroxymaleates, hydroxycarboxlic acids, hexylresorcinates, hydroxybenzoates, hydroxynaphthoate, hydrofluorate, lactates, lactobionates, laurates, malates, maleates, methylenebis(beta-oxynaphthoate), malonates, mandelates, mesylates, methane sulfonates, methylbromides, methylnitrates, methylsulfonates, monopotassium maleates, mucates, monocarboxylates, mitrates, naphthalenesulfonates, 2-naphthalenesulfonates, nicotinates, napsylates, N-methylglucamines, oxalates, octanoates, oleates, pamoates, phenylacetates, picrates, phenylbenzoates, pivalates, propionates, phthalates, phenylacetate, pectinates, phenylpropionates, palmitates, pantothenates, polygalacturates, pyruvates, quinates, salicylates, succinates, stearates, sulfanilate, subacetates, tartarates, theophyllineacetates, p-toluenesulfonates (tosylates), trifluoroacetates, terephthalates, tannates, teoclates, trihaloacetates, triethiodide, tricarboxylates, undecanoates and valerates.

In one embodiment, examples of inorganic basic salts may be selected from ammonium, alkali metals to include lithium, sodium, potassium, cesium; alkaline earth metals to include calcium, magnesium, aluminium; zinc, barium, cholines, quaternary ammoniums.

In another embodiment, examples of organic basic salts may be selected from arginine, organic amines to include aliphatic organic amines, alicyclic organic amines, aromatic organic amines, benzathines, t-butylamines, benethamines (N-benzylphenethylamine), dicyclohexylamines, dimethylamines, diethanolamines, ethanolamines, ethylenediamines, hydrabamines, imidazoles, lysines, methylamines, meglamines, N-methyl-D-glucamines, N,N′-dibenzylethylenediamines, nicotinamides, organic amines, ornithines, pyridines, picolies, piperazines, procain, tris(hydroxymethyl)methylamines, triethylamines, triethanolamines, trimethylamines, tromethamines and ureas.

An “alkyl” group refers, in one embodiment, to a saturated aliphatic hydrocarbon, including straight-chain, branched-chain and cyclic alkyl groups. In one embodiment, the alkyl group has 1-12 carbons. In another embodiment, the alkyl group has 1-7 carbons. In another embodiment, the alkyl group has 1-6 carbons. In another embodiment, the alkyl group has 6-12 carbons. In another embodiment, the alkyl group has 8-12 carbons. In another embodiment, the alkyl group has 1-4 carbons. The alkyl group may be unsubstituted or substituted by one or more groups selected from halogen, hydroxy, alkoxy carbonyl, amido, alkylamido, dialkylamido, nitro, amino, alkylamino, dialkylamino, carboxyl, thio and thioalkyl.

An “alkenyl” group refers, in another embodiment, to an unsaturated hydrocarbon, including straight chain, branched chain and cyclic groups having one or more double bond. The alkenyl group may have one double bond, two double bonds, three double bonds etc. Examples of alkenyl groups are ethenyl, propenyl, butenyl, cyclohexenyl etc. The alkenyl group may be unsubstituted or substituted by one or more groups selected from halogen, hydroxy, alkoxy carbonyl, amido, alkylamido, dialkylamido, nitro, amino, alkylamino, dialkylamino, carboxyl, thio and thioalkyl.

A “haloalkyl” group refers to an alkyl group as defined above, which is substituted by one or more halogen atoms, in one embodiment by F, in another embodiment by Cl, in another embodiment by Br, in another embodiment by I.

An “aryl” group refers to an aromatic group having at least one carbocyclic aromatic group or heterocyclic aromatic group, which may be unsubstituted or substituted by one or more groups selected from halogen, haloalkyl, hydroxy, alkoxy carbonyl, amido, alkylamido, dialkylamido, nitro, amino, alkylamino, dialkylamino, carboxy or thio or thioalkyl. Nonlimiting examples of aryl rings are phenyl, naphthyl, pyranyl, pyrrolyl, pyrazinyl, pyrimidinyl, pyrazolyl, pyridinyl, furanyl, thiophenyl, thiazolyl, imidazolyl, isoxazolyl, and the like. In one embodiment, the aryl group is a 1-12 membered ring. In another embodiment, the aryl group is a 1-8 membered ring. In another embodiment, the aryl group comprises of 1-4 fused rings.

In some embodiments, the invention is directed to noncovalent hybrid comprising a carbon nanotube (CNT) and at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber (ANF) their salt thereof and their derivative thereof.

In other embodiments, the carbon nanotube is a single-walled carbon nanotube (SWCNT). In other embodiments, the carbon nanotube is a (6,5)-single walled carbon nanotube. In other embodiments, the carbon nanotube is a multi-walled carbon nanotube (MWCNT). In other embodiments, the carbon nanotube is a combination of a multi-walled carbon nanotube (MWCNT) and a single walled carbon nanotube (SWCNT). “Carbon nanotubes” refers herein to sheets of graphene that form tubes. “Single-walled nanotube” as defined herein, refers to a nanotube that does not contain another nanotube. “Multi-walled carbon nanotube” refers herein to more than one nanotube within nanotubes (including for example double walled nanotube).

In some embodiments, the hybrid of this invention comprises between 5 wt % to 95 wt % of carbon nanotube (CNT). In other embodiments, the hybrid composition comprises between 30 wt % to 95 wt % of carbon nanotube (CNT). In other embodiments, the hybrid composition comprises between 50 wt % to 95 wt % of carbon nanotube (CNT). In other embodiments, the hybrid composition comprises between 70 wt % to 95 wt % of carbon nanotube (CNT). In other embodiments, the hybrid composition comprises between 5 wt % to 80 wt % of carbon nanotube (CNT). In other embodiments, the hybrid composition comprises between 5 wt % to 75 wt % of carbon nanotube (CNT). In other embodiments, the hybrid composition comprises between 5 wt % to 70 wt % of carbon nanotube (CNT). In other embodiments, the hybrid composition comprises between 5 wt % to 40 wt % of carbon nanotube (CNT). In other embodiments, the hybrid composition comprises between 5 wt % to 10 wt % of carbon nanotube (CNT). In other embodiments, the hybrid composition comprises between 5 wt % to 15 wt % of carbon nanotube (CNT). In other embodiments, the hybrid composition comprises between 10 wt % to 30 wt % of carbon nanotube (CNT). In other embodiments, the hybrid composition comprises between 5 wt % to 20 wt % of carbon nanotube (CNT). In other embodiments, the hybrid composition comprises between 15 wt % to 60 wt % of carbon nanotube (CNT). In other embodiments, the hybrid composition comprises between 20 wt % to 70 wt % of carbon nanotube (CNT). In other embodiments, the hybrid composition comprises between 35 wt % to 75 wt % of carbon nanotube (CNT). In other embodiments, the hybrid composition comprises between 65 wt % to 70 wt % of carbon nanotube (CNT).

In some embodiments, the hybrid comprises purpurin and SWCNT. In other embodiment, the hybrid comprises a 1:1 weight ratio of the purpurin and the SWCNT, respectively. In other embodiment, the hybrid comprises a 1:95 to 95:1 weight ratio of the purpurin and the SWCNT, respectively. In other embodiment, the hybrid comprises a 1:95 to 50:50 weight ratio of the purpurin and the SWCNT, respectively. In other embodiment, the hybrid comprises a 1:1, 1:10, 1:20, 1:30, 1:50; 1:70, 1:95 weight ratio of the purpurin and the SWCNT, respectively.

In some embodiments, the hybrid comprises alizarin and SWCNT. In other embodiment, the hybrid comprises a 1:1 weight ratio of the alizarin and the SWCNT respectively. In other embodiment, the hybrid comprises a 1:95 to 95:1 weight ratio of the alizarin and the SWCNT, respectively. In other embodiment, the hybrid comprises a 1:95 to 50:50 weight ratio of the alizarin and the SWCNT, respectively. In other embodiment, the hybrid comprises a 1:1, 1:10, 1:20, 1:30, 1:50; 1:70, 1:95 weight ratio of the alizarin and the SWCNT, respectively.

In some embodiments, the hybrid comprises purpurin and MWCNT. In other embodiment, the hybrid comprises a 1:1 weight ratio of the purpurin and the MWCNT. In other embodiment, the hybrid comprises a 1:95 to 95:1 weight ratio of the purpurin and the MWCNT, respectively. In other embodiment, the hybrid comprises a 1:95 to 50:50 weight ratio of the purpurin and the MWCNT, respectively. In other embodiment, the hybrid comprises a 1:1, 1:10, 1:20, 1:30, 1:50; 1:70, 1:95 weight ratio of the purpurin and the MWCNT, respectively.

In some embodiments, the hybrid comprises alizarin and MWCNT. In other embodiment, the hybrid comprises a 1:1 weight ratio of the alizarin and the MWCNT, respectively. In other embodiment, the hybrid comprises a 1:95 to 95:1 weight ratio of the alizarin and the MWCNT, respectively. In other embodiment, the hybrid comprises a 1:95 to 50:50 weight ratio of the alizarin and the MWCNT, respectively. In other embodiment, the hybrid comprises a 1:1, 1:10, 1:20, 1:30, 1:50; 1:70, 1:95 weight ratio of the alizarin and the MWCNT, respectively.

In some embodiments, the hybrid comprises aramid nanofiber (ANF) and SWCNT. In other embodiment, the hybrid comprises a 1:1 weight ratio of the aramid nanofiber (ANF) and the SWCNT, respectively. In other embodiment, the hybrid comprises a 1:95 to 95:1 weight ratio of the aramid nanofiber (ANF) and the SWCNT, respectively. In other embodiment, the hybrid comprises a 1:95 to 50:50 weight ratio of the aramid nanofiber (ANF) and the SWCNT, respectively. In other embodiment, the hybrid comprises a 1:1, 1:10, 1:20, 1:30, 1:50; 1:70, 1:95 weight ratio of the aramid nanofiber (ANF) and the SWCNT, respectively.

In some embodiments, the hybrid comprises aramid nanofiber (ANF) and MWCNT. In other embodiment, the hybrid comprises a 1:1 weight ratio of the aramid nanofiber (ANF) and the MWCNT, respectively. In other embodiment, the hybrid comprises a 1:95 to 95:1 weight ratio of the aramid nanofiber (ANF) and the MWCNT, respectively. In other embodiment, the hybrid comprises a 1:95 to 50:50 weight ratio of the aramid nanofiber (ANF) and the MWCNT, respectively. In other embodiment, the hybrid comprises a 1:1, 1:10, 1:20, 1:30, 1:50; 1:70, 1:95 weight ratio of the aramid nanofiber (ANF) and the MWCNT, respectively.

In some embodiments, the hybrid provided herein is in a form of a dispersion, buckypapers, a coating, a bulk material, paste, a powder or an aerogel. In other embodiments, the hybrid provided herein is a dispersion in an organic or aqueous solvent. In other embodiments, the hybrid provided herein is a buckypaper or a film. In other embodiments, the hybrid provided herein is used as coating. In other embodiments, the hybrid provided herein is a powder. In other embodiments, the hybrid provided herein is a coating. In other embodiments, the hybrid provided herein is a paste. In other embodiments, the hybrid provided herein is an aerogel. In other embodiments, the coating is a powder coating.

In some embodiments, the hybrid provided herein is conductive.

In some embodiments, the hybrid provided herein is hydrophilic.

A “bulk material” refers herein to a material where the hybrid is dispersed in it in 3D.

### Process for the Preparation of Noncovalent Hybrids

In some embodiments, this invention provides a process for the preparation of noncovalent hybrid comprising a carbon nanotube (CNT) and at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber (ANF) their salt thereof and their derivative thereof; the process comprises:
optionally grinding the carbon nanotube; and
mixing the carbon nanotube and the at least one aromatic compound in a sonication bath in an aqueous solvent, an organic solvent, or combination thereof and sonicated for a period of time to obtain a dispersion comprising the hybrid.

In some embodiments, this invention provides a process for the preparation of noncovalent hybrid comprising a carbon nanotube (CNT) and at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber (ANF) their salt thereof and their derivative thereof; the process comprises:
grinding the carbon nanotube; and
mixing the carbon nanotube and the at least one aromatic compound in a sonication bath in an aqueous solvent, an organic solvent, or combination thereof and sonicated for a period of time to obtain a dispersion comprising the hybrid.

In some embodiments, the mixing step in the sonication bath is for a period of sonication ranging between 15 min to one hour.

In another embodiment the grinding/milling is performed in a solid grinder at between 50-100 krpm for a period of between 2 minutes to 1 hour. In another embodiment, the grinding/milling is performed for a period of between 2 minutes to 10 minutes. The term grinding and milling are used herein interchangeably.

In some embodiments, the process for the preparation of the hybrid of this invention is further purified by centrifugation, filtration, or precipitation to yield homogeneous hybrid.

In some embodiment, the organic solvent used in the preparation of the hybrid is chloroform, methylene chloride, carbon tetrachloride dichloroethane, glyme, diglyme, triglyme, triethylene glycol, trichloroethane, tertbutyl methyl ether, tetrachloro ethane, acetone, THF, DMSO, toluene, benzene, alcohol, isopropyl alcohol (IPA), chlorobenzene, acetonitrile, dioxane, ether, NMP, DME, DMF, ethyl-acetate or combination thereof. Each represents a separate embodiment of this invention.

The process for the preparation of the hybrids provided herein comprises a sonication step. The sonication, mechanically and chemically altered CNTs in solution. Bath sonication of CNTs in the presence of an aromatic molecules in a preferred solvent disperses the CNTs in a way that enables improved processing by spray-coating, filtration, casting and bulk composite applications.

In some embodiments, the hybrid prepared by the process provided herein has improved spraying, filtration, or printing properties compared to carbon nanotubes (not hybrids). In some embodiments, the hybrid prepared by the process provided herein has improved spraying, filtration, or printing properties compared to hybrids, where the carbon nanotube was not milled/grinded prior to mixing with an aromatic compound.

The aromatic compounds within the hybrids provided herein, modify the surface energy of the adsorbing nanotubes for better solution dispersibility and adhesion.

### A Composite Comprising the Noncovalent Hybrid Provided Herein and Uses Thereof.

Both SWCNT and MWCNT have similar uses as adsorptive materials, conductive fibers, sheets and fabrics, porous electrodes, coatings or membranes, conductive inks, conductive and/or reinforcing additives to material composites, and part of electro-sensing, electro-catalytic or photovoltaic systems. They differ by porosity, electrical and thermal conductivity; chemical, thermal and photonic stability; surface energy; chemical adsorptivity; tensile strength and more. Their specific use may be tailored to a specific application using the hybrids provided herein.

In some embodiments, this invention provides a composite comprising a polymer and a noncovalent hybrid comprising a carbon nanotube (CNT) and at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber (ANF) their salt thereof and their derivative thereof, wherein the composite has improved mechanical and/or conductivity compared to CNT alone (i.e. not a hybrid). In other embodiments, the carbon nanotube is a single-walled carbon nanotube. In other embodiments, the carbon nanotube is a multi-walled carbon nanotube.

In other embodiments, the polymer is any known organic polymer with melting point higher than 25° C. In other embodiments, the polymers comprise polyethylene, polypropylene, ABS, nylons, polystyrene, polyvinyl chloride, polylactic acid, polyurethanes, polyester, epoxy resin, poly acrylates, PEEK and more (e.g. any polymer that can be used in a 3D printer) and their combination and/or copolymers.

In some embodiments, this invention provides a porous electrode for electrochemical application, comprising a noncovalent hybrid comprising a carbon nanotube (CNT) and at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber (ANF) their salt thereof and their derivative thereof. In other embodiments, the electrochemical application comprises circular voltammetry, a sensor, an energy storage, and an energy conversion. In other embodiments, the carbon nanotube is a single-walled carbon nanotube. In other embodiments, the carbon nanotube is a multi-walled carbon nanotube.

In some embodiments, the hybrid provided herein is used for the preparation of electrodes. In other embodiments, the hybrid provided herein is used for the preparation of porous electrodes. In other embodiments, the hybrid provided herein is used for the preparation of transparent electrodes.

In one embodiment, the electrode comprises the hybrid provided herein and/or nanoparticles and/or polymers in a way that will enable appropriate surface energy, selectivity, surface area, porosity, and chemical and thermal stability needed for their utilization in the mentioned systems.

In some embodiments, this invention provides a stretchable, flexible and/or inflatable material comprising a noncovalent hybrid comprising a carbon nanotube (CNT) and at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber (ANF) their salt thereof and their derivative thereof. In another embodiment, the hybrid is conductive, and the conductivity of the hybrid is maintained upon stretching or inflation of the material. In other embodiments, the material is coated by the hybrid. In other embodiments, the hybrid is embedded within the material. In other embodiments, the hybrid is a coating on the surface of the material. In other embodiments, the carbon nanotube is a single-walled carbon nanotube. In other embodiments, the carbon nanotube is a multi-walled carbon nanotube.

In other embodiments, the stretchable, flexible and/or inflatable material a fabric, a stretchable textile, a paper, or an elastomer (e.g. latex, rubber, polyurethane, silicone). In other embodiments, the elastomer is latex, rubber, polyurethane or silicone.

In some embodiments, this invention provides an EMI (electromagnetic interference) shielding and electromagnetic radiation absorbers comprising a noncovalent hybrid comprising a carbon nanotube (CNT) and at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber (ANF) their salt thereof and their derivative thereof. In other embodiments, the electrochemical application comprises circular voltammetry, a sensor, an energy storage, and an energy conversion, wherein the hybrid is conductive in the infrared and microwave ranges. The EMI shielding or the electromagnetic radiation absorbers are made of conductive CNT hybrid. EMI shields are faraday cages constructed around a device or an object needed to be shielded from EMI. In other embodiments, the carbon nanotube is a single-walled carbon nanotube. In other embodiments, the carbon nanotube is a multi-walled carbon nanotube.

In some embodiments, this invention provides a construction material, wherein the construction material comprises a noncovalent hybrid comprising a carbon nanotube (CNT) and at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber (ANF) their salt thereof and their derivative thereof, wherein the hybrid reinforces the construction material compared to CNT alone (not a hybrid). In other embodiments, the carbon nanotube is a single-walled carbon nanotube. In other embodiments, the carbon nanotube is a multi-walled carbon nanotube.

In another embodiment, the hybrid provided herein is embedded within the construction material. In another embodiment, the construction material is coated by the hybrid. In other embodiments, the construction material comprises concrete, a gypsum or construction polymers. In other embodiments, the construction polymers comprise polyethylene, polypropylene, ABS, nylons, polystyrene, polyvinyl chloride, polylactic acid, polyurethanes, polyester, epoxy resin, poly acrylates, PEEK and more (e.g. any polymer that can be used in a 3D printer) and their combination and/or copolymers.

In some embodiments, the hybrid provided herein is used for the preparation of construction material.

In other embodiments the hybrid is embedded in glass made by xerogel methods.

In some embodiments, this invention provide a dispersion comprising a noncovalent hybrid comprising a carbon nanotube (CNT) and at least one aromatic compound, wherein the aromatic compound is selected from the group consisting of anthraquinone, acridine, naphthalene disulfonic acid, caffeic acid, phenazine, indigo, rhodamine, phenothiazine, thymolphthalein, aramid nanofiber (ANF) their salt thereof and their derivative thereof in organic or aqueous solvent. In other embodiments, the carbon nanotube is a single-walled carbon nanotube. In other embodiments, the carbon nanotube is a multi-walled carbon nanotube.

In other embodiment, the dispersion dispersibility of CNTs in organic solvents and water is up to 2 g/1.

In other embodiments, the dispersion is filtered on a filter forming a hydrophilic or a hydrophobic buckypaper on the filter. The hydrophobicity or hydrophilicity is determined by the properties of the aromatic compounds within the hybrids. In one embodiment, the buckypaper is hydrophilic and is used for water-oil separation or desiccation. In one embodiment, the buckypaper is hydrophobic and is used for protecting surfaces from humidity and liquid water, water soluble materials (e.g. self-cleaning surfaces), while staying permeable to other gasses or organic liquids. The hydrophobic buckyball can be used also for protecting a substrate from regular organic materials that are not polyhalogenated.

In some embodiments a hybrid dispersion is applied on solid surfaces such as non limiting examples of glass, silicon oxide, PP, PVC, PET and paper by drop casting, dipping, spray coating, filtration, printing or powder coating to form conductive hybrid films on solid surfaces (substrates). In other embodiments the film can be transferred to another solid surface by hot press. In other embodiments, the film is transferred as exemplified in Example 1 and Example 2.

### An Electrode Comprising the Noncovalent Hybrid and an Active Material, Processes of Preparation Thereof and Lithium-Ion Cell Comprising the Same.

In some embodiments, this invention provides an electrode comprising the noncovalent hybrid provided herein. In one other embodiment, the electrode comprises the noncovalent hybrid and an active material. In one other embodiment, the electrode comprises the noncovalent hybrid and an active material; and optionally a binder and/or a charge collector. In another embodiment, the noncovalent hybrid comprises a carbon nanotube and anthraquinone or derivative thereof. In another embodiment, the electrode is a cathode or an anode. In another embodiment, the electrode is a cathode. In another embodiment, the electrode is an anode. In another embodiment, the cathode comprises a cathode active material. In another embodiment, the anode comprises an anode active material.

In some other embodiments, the anthraquinone or derivative thereof is represented by the structure of formula I as described hereinabove in the section “Noncovalent hybrid”. In one embodiment, the anthraquinone derivative is dihydroxy or trihydroxy anthraquinone. In another embodiment, the anthraquinone derivative is alizarin or purpurin. In another embodiment, the dihydroxy anthraquinone is alizarin.

In some other embodiments, the carbon nanotube is a single- or a multi-walled carbon nanotube. In one embodiment, the carbon nanotube is a single-walled carbon nanotube. In one other embodiment, the carbon nanotube is a multi-walled carbon nanotube.

In some other embodiments, the electrode is a cathode and the cathode comprises “a cathode active material” as described in e.g. Lithium ion battery chemistries: a primer; Warner, J. T. (2019); Chapter 5: The cathodes (which is incorporated herein by reference in its entirety). In one embodiment, the cathode active material comprises a lithium based material. In one further embodiment, the lithium based material comprises lithium iron phosphate, lithium cobalt oxide, lithium manganese oxide, lithium nickel manganese cobalt oxide (also known as “lithium nickel cobalt manganese oxide”), lithium nickel cobalt aluminum oxide, lithium nickel oxide, lithium iron manganese phosphate, lithium nickel manganese oxide, lithium manganese phosphate, lithium cobalt phosphate, lithium nickel cobalt phosphate, lithium iron fluorosulfate or any combination thereof. In one embodiment, the lithium based material comprises lithium nickel cobalt manganese oxide. Each possibility represents a separate embodiment of this invention.

In some other embodiments, the lithium iron phosphate comprises LiFePO₄, LiFeMgPO₄, LiFeMnPO₄, LiFeCoPO₄, LiFeMgPO₄, LiMnFeCoPO₄ or any combination thereof. In some other embodiments, the lithium cobalt oxide comprises LiCoO₂. In some other embodiments, the lithium manganese oxide comprises LiMn₂O₄, Li₂MnO₃ or any combination thereof. In some other embodiments, the lithium nickel manganese cobalt oxide comprises LiNiMnCoO₂ (NMC or NCM), LiNi_{0.33}Mn_{0.33}Co_{0.33}O₂, LiNi_{0.4}Mn_{0.3}Co_{0.3}O₂, LiNi_{0.5}Mn_{0.3}Co_{0.2}O₂, LiNi_{0.6}Mn_{0.2}Co_{0.2}O₂, LiNi_{0.7}Mn_{0.2}Co_{0.1}O₂, LiNi_{0.8}Mn_{0.1}Co_{0.1}O₂ (NMC811), LiNi_{0.4}Mn_{0.2}Co_{0.4}O₂, LiNi_{0.9}Mn_{0.1}O₂ or any combination thereof. In some other embodiments, lithium nickel cobalt aluminum oxide comprises LiNiCoAlO₂ (NCA) or LiNi_{0.8}Co_{0.15}Al_{0.05}O₂ or any combination thereof. In some other embodiments, lithium nickel oxide comprises LiNiO₂(LNO). In some other embodiments, lithium iron manganese phosphate comprises LiFeMnPO4. In some other embodiments, lithium nickel manganese oxide comprises Li[Li_{0.11}Ni_{0.33}Mn_{0.56]O}₄, LiNi_{0.5}Mn_{0.5}O₂, LiNi_{0.5}Mn_{1.5}O₄ or any combination thereof. In some other embodiments, lithium manganese phosphate comprises LiMnPO₄. In some other embodiments, lithium cobalt phosphate comprises LiCoPO₄. In some other embodiments, lithium nickel cobalt phosphate comprises LiNiCoPO₄. In some other embodiments, lithium iron fluorosulfate comprises LiFeSO₄F. In one embodiment, the lithium nickel manganese cobalt oxide material is LiNi_{0.8}Co_{0.1}Mn_{0.1}O₂(NMC811). Each possibility represents a separate embodiment of this invention.

In some other embodiments, the electrode is an anode and the anode comprises “anode active material” as described in e.g. Lithium ion battery chemistries: a primer; Warner, J. T. (2019); Chapter 6: The anodes (which is incorporated herein by reference in its entirety). In one embodiment, the anode active material comprises graphite, soft/amorphous carbon, hard carbon, graphene, lithium titanium oxide (e.g. Li₄Ti₅O₁₂), Si, Sn, Sb, Al, Ge, Mg; graphite combined (e.g. coated) with carbon black, coke, soft/amorphous carbon, and/or carbon nanotubes; graphene coated or combined with silicon, tin or transition metals; nanometric and/or porous Si, Sn, Sb, Al, Ge, Mg materials; core Si, Sn, Sb, Al, Ge, Mg materials coated with shell of carbon or alumina; Si/C or Si/graphite blends or Si cores with graphite/C shells; Sn—Co-graphite composites or Sn—Co-graphite-Ti composites; porous and/or nanostructured Sn or Sn—Ni alloyed cores with polymer shells; Sn oxides; Sn nitrides, sulfides or fluorides; Sn alloyed with copper, oxygen, nickel, iron zinc, cobalt; Al—Ni alloys; Al oxides; Ge-graphite or nanometric Ge-graphites composites; or any combination thereof. In one embodiment, the anode active material comprises graphite. Each possibility represents a separate embodiment of this invention.

In one specific embodiment, the electrode comprises NMC811 (LiNi_{0.8}Co_{0.1}Mn_{0.1}O₂) as an active material and a noncovalent hybrid which comprises alizarin and single- or multi-walled carbon nanotubes.

In one specific embodiment, the electrode comprises NMC811 (LiNi_{0.8}Co_{0.1}Mn_{0.1}O₂) as an active material and a noncovalent hybrid which comprises alizarin and single-walled carbon nanotubes.

In one specific embodiment, the electrode comprises graphite and a noncovalent hybrid which comprises alizarin and single- or multi-walled carbon nanotubes.

In one specific embodiment, the electrode comprises graphite and a noncovalent hybrid which comprises alizarin and single-walled carbon nanotubes.

In some other embodiments, the carbon nanotube within the electrode is in a weight of 6-20 mg. In one embodiment, the carbon nanotube within the electrode is in a weight of 6-10 mg. In another embodiment, the carbon nanotube within the electrode is in a weight of 10-20 mg. In another embodiment, the carbon nanotube within the electrode is in a weight of 10-15 mg. In another embodiment, the carbon nanotube within the electrode is in a weight of 15-20 mg. In another embodiment, the carbon nanotube within the electrode is in a weight of 12 mg. In another embodiment, the carbon nanotube within the electrode is a single walled carbon nanotube in a weight of 12 mg.

In some other embodiments, the anthraquinone or derivative thereof within the electrode is in a weight of 0.1-2 mg. In another embodiment, the anthraquinone or derivative thereof within the electrode is in a weight of 0.8-2 mg. In one embodiment, the anthraquinone or derivative thereof within the electrode is in a weight of 0.1-0.5 mg. In another embodiment, the anthraquinone or derivative thereof within the electrode is in a weight of 0.5-0.75 mg. In another embodiment, the anthraquinone or derivative thereof within the electrode is in a weight of 0.75-1 mg. In another embodiment, the anthraquinone or derivative thereof within the electrode is in a weight of 0.5-1 mg. In another embodiment, the anthraquinone or derivative thereof within the electrode is in a weight of 1-1.5 mg. In another embodiment, the anthraquinone or derivative thereof within the electrode is in a weight of 1-2 mg. In another embodiment, the anthraquinone or derivative thereof within the electrode is in a weight of 1.5-2.0 mg. In another embodiment, the anthraquinone or derivative thereof within the electrode is in a weight of 0.84 mg. In another embodiment, the anthraquinone or derivative thereof within the electrode is alizarin, in a weight of 0.84 mg. Each possibility represents a separate embodiment of this invention.

In some other embodiments, the active material within the electrode is in a weight of 60-400 mg. In one embodiment, the active material within the electrode is in a weight of 60-100 mg. In another embodiment, the active material within the electrode is in a weight of 100-120 mg. In another embodiment, the active material within the electrode is in a weight of 120-150 mg. In another embodiment, the active material within the electrode is in a weight of 150-175 mg. In another embodiment, the active material within the electrode is in a weight of 175-200 mg. In another embodiment, the active material within the electrode is in a weight of 110-130 mg. In another embodiment, the active material within the electrode is in a weight of 100-120 mg. In another embodiment, the active material within the electrode is in a weight of 100-200 mg. In another embodiment, the active material within the electrode is in a weight of 200-300 mg. In another embodiment, the active material within the electrode is in a weight of 300-400 mg. In another embodiment, the active material within the electrode is in a weight of 350-400 mg. In another embodiment, the active material within the electrode is in a weight of 300-350 mg. In another embodiment, the active material within the electrode is in a weight of 200-250 mg. In another embodiment, the active material within the electrode is in a weight of 100-300 mg. In another embodiment, the active material within the electrode is in a weight of 200-400 mg. In another embodiment, the active material within the electrode is in a weight of 100-400 mg. In another embodiment, the active material within the electrode is in a weight of 250-300 mg. In another embodiment, the active material within the electrode is in a weight of 150-350 mg. In another embodiment, the active material within the electrode is in a weight of 150-400 mg. In another embodiment, the active material within the electrode is in a weight of 120 mg. In another embodiment, the active material within the electrode is in a weight of 228 mg. In another embodiment, the active material within the electrode is NMC811, in a weight of 120 mg. In another embodiment, the active material within the electrode is graphite in a weight of 228 mg. Each possibility represents a separate embodiment of this invention.

In some other embodiments, the weight ratio of carbon nanotube:anthraquinone or derivative thereof:active material is 6-20:0.1-2: 60-400. In one embodiment, the weight ratio is 10-20:0.8-2: 100-400. In another embodiment, the ratio is 12:0.84:120. In another embodiment, the ratio is 12 SWCNT:0.84 alizarin:120 NMC811. In another embodiment, the ratio is 12:0.84:228. In another embodiment, the ratio is 12 SWCNT:0.84 alizarin:228 graphite. Each possibility represents a separate embodiment of this invention.

In some other embodiments, the electrode is circular and the average two point resistance around the diameter of the electrode is between 2 and 4Ω. In one embodiment, the average two point resistance around the diameter of the electrode is between 2 and 3Ω. In one other embodiment, the average two point resistance around the diameter of the electrode is between 3 and 4Ω. In one other embodiment, the average two point resistance around the diameter of the electrode is between 3 and 3.5Ω. In one other embodiment, the average two point resistance around the diameter of the electrode is between 3.5 and 4Ω. In one other embodiment, the average two point resistance around the diameter of the electrode is between 2 and 2.5Ω. In one other embodiment, the average two point resistance around the diameter of the electrode is between 2.5 and 3Ω. In another embodiment, the average two point resistance around the diameter is 3.1±0.1Ω.

In some other embodiments, the average thickness of the electrode is between 10 and 400 μm. In one embodiment, the average thickness is between 10 and 30 μm. In one other embodiment, the average thickness is between 30 and 50 μm. In one other embodiment, the average thickness is between 50 and 70 μm. In one other embodiment, the average thickness is between 70 and 90 μm. In one other embodiment, the average thickness is between 90 and 110 μm. In one other embodiment, the average thickness is between 70 and 80 μm. In one other embodiment, the average thickness is between 80 and 90 μm. In one other embodiment, the average thickness is between 90 and 100 μm. In one other embodiment, the average thickness is between 100 and 110 μm. In one other embodiment, the average thickness is between 80 and 100 μm. In one other embodiment, the average thickness is between 100 and 200 μm. In one other embodiment, the average thickness is between 200 and 300 μm. In one other embodiment, the average thickness is between 300 and 400 μm. In one other embodiment, the average thickness is between 200 and 250 μm. In one other embodiment, the average thickness is between 250 and 300 μm. In one other embodiment, the average thickness is between 300 and 350 μm. In one other embodiment, the average thickness is between 350 and 400 μm. In one other embodiment, the average thickness is between 200 and 400 μm. In one other embodiment, the average thickness is between 50 and 100 μm. In one other embodiment, the average thickness is between 50 and 150 μm. In one other embodiment, the average thickness is between 150 and 300 μm. In one other embodiment, the average thickness is between 100 and 300 μm. In one other embodiment, the average thickness is between 250 and 400 μm. In one other embodiment, the average thickness is between 150 and 400 μm. In one other embodiment, the average thickness is between 10 and 100 μm. In another embodiment, the average thickness is 88±7 μm. In another embodiment, the average thickness is 296±5 μm.

In some embodiments, this invention provides a lithium-ion cell comprising an anode, a cathode, an electrolyte, and a separator wherein at least one of the anode and cathode comprises a noncovalent hybrid, an active material and optionally a binder and/or a charge collector, wherein the hybrid comprises a carbon nanotube and anthraquinone or derivative thereof. In one embodiment, both the anode and cathode comprise a noncovalent hybrid and an active material, and optionally a binder and/or a charge collector. In one other embodiment, the anode comprises a noncovalent hybrid, an anode active material and optionally a binder and/or a charge collector, and the cathode comprises a cathode active material, conductive material and optionally a binder and/or a charge collector. In one other embodiment, the cathode comprises a noncovalent hybrid, a cathode active material and optionally binder and/or a charge collector, and the anode comprises an anode active material, conductive material and optionally a binder and/or a charge collector. In some other embodiments, the anode active material comprises graphite, soft/amorphous carbon, hard carbon, graphene, lithium titanium oxide, Si, Sn, Sb, Al, Ge, Mg or any combination thereof; or any anode active material as described hereinabove and in e.g. Lithium ion battery chemistries: a primer; Warner, J. T. (2019); Chapter 6: The anodes (which is incorporated herein by reference in its entirety). In one embodiment, the anode active material comprises graphite. In some other embodiments, the cathode active material comprises a lithium based material. In some further embodiments, the lithium based material comprises lithium iron phosphate, lithium cobalt oxide, lithium manganese oxide, lithium nickel manganese cobalt oxide (also known as “lithium nickel cobalt manganese oxide”), lithium nickel cobalt aluminum oxide, lithium nickel oxide, lithium iron manganese phosphate, lithium nickel manganese oxide, lithium manganese phosphate, lithium cobalt phosphate, lithium nickel cobalt phosphate, lithium manganese iron cobalt phosphate, lithium iron fluorosulfate or any combination thereof; or any cathode active material as described hereinabove and in e.g. Lithium ion battery chemistries: a primer; Warner, J. T. (2019); Chapter 5: The cathodes (which is incorporated herein in its entirety). In one embodiment, the lithium based material comprises lithium nickel cobalt manganese oxide. In another embodiment, the lithium based material is LiNi_{0.8}Co_{0.1}Mn_{0.1}O₂(NMC811).

In some other embodiments, the electrolytes are described in e.g. Lithium ion battery chemistries: a primer; Warner, J. T. (2019); Chapter 7: Inactive materials (which is incorporated herein by reference in its entirety). It is noted that the purpose of the electrolyte, is to create a path for the ions in a cell (here, lithium ions) to traverse back and forth between the cell's electrodes (Id.). In one embodiment, the electrolyte comprises a lithium salt and an organic solvent. In another embodiment, the solvent comprises ethylene carbonate (EC), dimethylcarbonate (DMC), diethyl carbonate (DEC), propylene carbonate (PC), ethylmethylcarbonate (EMC), ethylpropylcarbonate (EPC), methylpropylcarbonate (MPC), diethylether, 1,2-dimethoyxethane, tetrahydrofuran (THF), diglyme, 2-methyltetrahydrofurran, g-butyorlactone (BL), g-valerolactone (VL), sulfonemethane, acetonitrile, adiponitrile or any combination thereof. In one other embodiment, the lithium salt comprises LiPF₆, LiBF₄ or any combination thereof. In some other embodiment, the electrolyte further comprises additives (Id.; specifically, section 7.2.2). In another embodiment, the electrolyte is LP30 (1M LiPF₆ in a 50:50 EC (ethylene carbonate):DMC (dimethylcarbonate)).

In some other embodiments, the separators are described in e.g. Lithium ion battery chemistries: a primer; Warner, J. T. (2019); Chapter 7: Inactive materials (which is incorporated herein by reference in its entirety). It is noted that the separator is a type of ultrathin, porous membrane that allows for the physical separation of the positive and negative electrodes. It is responsible for keeping the anode and cathode electrodes electrically separated and thereby preventing a short circuit. Subsequently, it is a primary safety component within a cell. But it is also a critical component in the operation of the cell as it must have enough porosity to allow the lithium-ions in the electrolyte to pass back and forth between anode and cathode, but not allow the electrons to pass, which means that it must be ionically conductive but electrically isolating (Id.). In one embodiment, the separator comprises borosilicate, polyethylene (PE), polypropylene (PP); or alumina, silica, titanium (titania) magnesia or other ceramic material coated PE or PP; nonwoven separator formed from materials such as liquid crystalline polyester, aromatic polyamide/polyester (e.g. polyethylene terephthalate (PET) or Poly(butylene) terephthalate (PBT)) or cellulose; silicone rubber, fluororubber, aromatic polyamide resins, liquid crystalline or Kevlar®; or an combination thereof. In another embodiment, the separator comprises a borosilicate. In another embodiment, the separator is trilayer structure comprising PP, PE and PP layers.

In some embodiments, the anode active material as described hereinabove (in regards to e.g. electrodes and lithium-ion cells of this invention) further comprises, besides the listed materials—a lithium metal. In one embodiment, the anode is a lithium metal (shaped as an electrode).

In some other embodiments, the binder as optionally found in the electrode and/or lithium-ion cell of this invention is described in e.g. Lithium ion battery chemistries: a primer; Warner, J. T. (2019); Chapter 7: Inactive materials (which is incorporated herein by reference in its entirety). It is noted that binders are the materials that hold the active material molecules together and hold the active material to the current collector, i.e. being the “glue” that holds the active material together and keeps everything from falling apart; and it also helps the active material to maintain good electrical connection with the current collector and creates a good path for electrical conduction (Id.). In one embodiment, the binder comprises soft carbon called carbon black, sometimes branded as “Super P” carbon black (SPCB); polyvinylidene fluoride (PVDF); anode specific binders such as styrene butadiene (SBR) copolymer, carboxymethylcellulose (CMC) and ethylene-propylene-diene methylene (EPDM); or any combination thereof. Each possibility represents a separate embodiment of this invention.

In some other embodiments, the charge collector as optionally found in the electrode and/or lithium-ion cell of this invention is described in e.g. Lithium ion battery chemistries: a primer; Warner, J. T. (2019); Chapter 7: Inactive materials (which is incorporated herein by reference in its entirety). In some embodiments, the term charge collector and current collector is used interchangeably; and it is a battery component responsible for transferring the flow of electrons from the electrodes to an external circuit. In one embodiment, the charge collector is a foil. In one embodiment, the charge collector comprises copper or aluminum (usually as foils). In one embodiment, aluminum is used for the cathode and copper for the anode. In one other specific embodiment of lithium titanate oxide cells, the aluminum is used on both electrodes (anode and cathode). In another embodiment, the aluminum or copper are coated, e.g. with carbon black. In another embodiment, the copper is a copper nanowire. In one other embodiment, the charge collector is a 3D charge collector comprising nanotubes grown on the surface of the metallic (Al/Cu) foils. In one further embodiment, the charge collector comprises graphite sheets and carbon nanotubes (CNT) or vertically aligned carbon nanotubes (VACNT).

In some other embodiments, the conductive material within the lithium-ion cell of this invention (in a cathode or an anode which do not comprise the CNT/anthraquinone hybrid) comprises carbon, carbon black, graphite, graphene or any combination thereof.

In some embodiments, the electrodes of this invention (e.g. the ones comprising the noncovalent hybrid and an active material) are free-standing. In some further embodiments, the free-standing electrodes do not include binders or charge/current collectors. In some other embodiments, the free-standing electrodes are used in the lithium-ion cells of this invention as described hereinabove. In view of the lack of usually required components such as e.g. binders and current collectors in the free-standing electrodes—it is surprising that they are mechanically robust and perform (inter-alia, electrochemically) well.

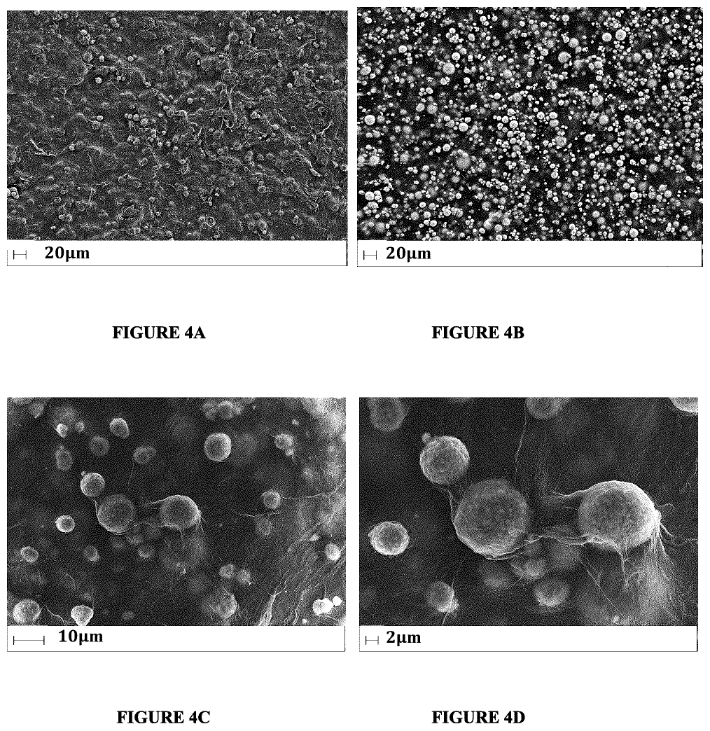

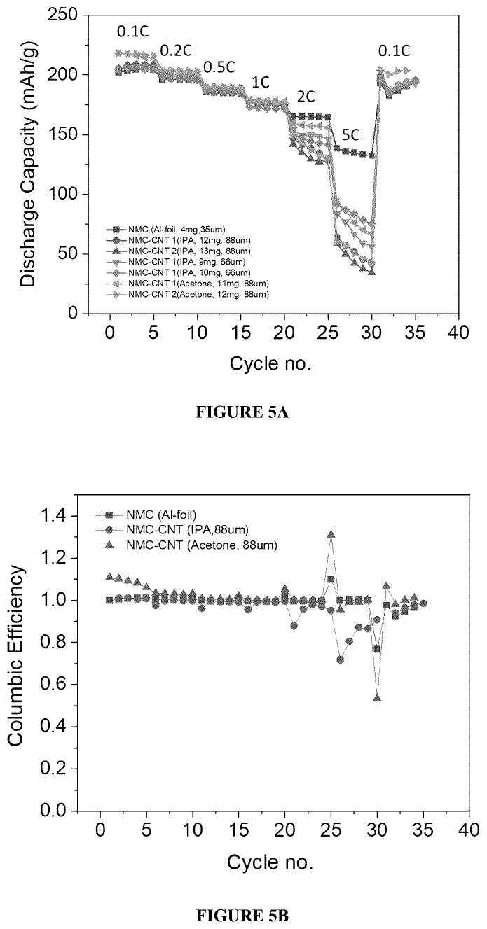

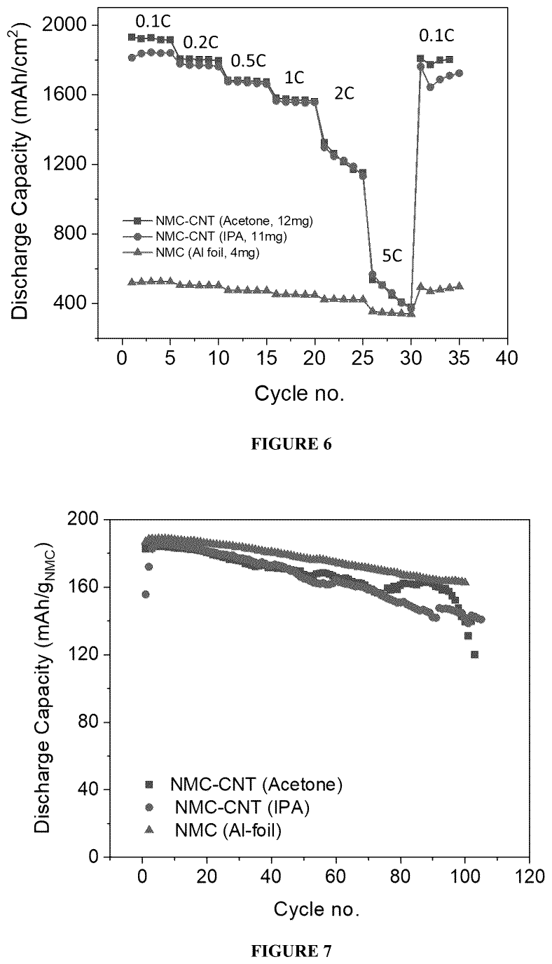

In some embodiments, the electrodes and/or lithium-ion cells of this invention are stable and durable and can perform well for above 20, 25, 30 or for even 100 cycles at various current densities. In some embodiments, the columbic efficiency stayed constant until 30 cycles (FIG. 5B). In some embodiments, mass-normalized discharge capacity of electrodes of this invention (FIG. 5A) is equal to or slightly better (better especially in higher charge rates, namely 2 C, 5 C) than reference NMC electrodes comprising NMC (e.g. NMC811), but lacking hybrid (e.g. SWCNT/alizarin) of this invention. In some embodiments, surface-area-normalized discharge capacity of electrodes of this invention (FIG. 6) is substantially better (at charge rates of 0.1 C-5 C) than said reference NMC electrodes. In some embodiments, the electrodes of this invention have stability under constant current which is similar or comparable to the one of the reference electrodes (FIG. 7). In some other embodiments, the reference electrodes lack the hybrid of this invention, and comprise NMC (e.g. NMC811), binder and carbon particles (as conductive material) coated on Al foil.

In some embodiments, this invention provides a process of preparing an electrode comprising an active material and a noncovalent hybrid and optionally a binder and/or a charge collector, as described hereinabove, wherein the hybrid comprises a carbon nanotube and anthraquinone or derivative thereof, wherein the process comprises:
sonicating a solution comprising the carbon nanotube, anthraquinone or derivative thereof and a first solvent;
adding the sonicated solution to a dispersion of the active material dispersed in a second solvent, and sonicating the resulting mixture;
filtering the resulting sonicated mixture comprising the active material, the carbon nanotube and anthraquinone or derivative thereof;
putting the obtained retentate in a roll press; and
separating the provided film from the roll press to obtain the electrode.

In some other embodiments, the process further comprises covering the obtained electrode with a charge collector foil. In another embodiment, the foil comprises aluminum for a cathode or copper for an anode.

In some other embodiments, the components: active material, carbon nanotubes and anthraquinone or derivative thereof, binder and/or charge collector—are as described hereinabove in the sections concerning the electrode comprising said components, in terms of their identity (specific structures/species) and properties (amounts, characteristics etc.).

In some other embodiments, the first and second solvents are identical. In one embodiment, the first and second solvents are different. In another embodiment, the first and second solvents are acetone or isopropyl alcohol (IPA). In another embodiment, the first and second solvents are acetone. In another embodiment, the first and second solvents are IPA.

In some other embodiments, sonication at the various stages of the process can be performed in any conditions appropriate in order to form the dispersions/solutions as required in said process, e.g. for various sequences, times and temperatures. In one embodiment, the sonication is done at a 50-200 120W pulsed sequence for a few seconds to 1 hour 10-30 minutes (or between few seconds to 15 seconds) at 20° C. In one other embodiment, the sonication is done at a 120W pulsed sequence for a few seconds, 15 seconds or 10-30 minutes at 20° C.

In some other embodiments, the roll press was performed at 20-180° C. In one embodiment, the roll press was performed at 20-25° C. In another embodiment, the roll press was performed at 25-30° C. In another embodiment, the roll press was performed at 30-50° C. In another embodiment, the roll press was performed at 50-70° C. In another embodiment, the roll press was performed at 70-100° C. In another embodiment, the roll press was performed at 100-120° C. In another embodiment, the roll press was performed at 120-150° C. In In another embodiment, the roll press was performed at 150-180° C. another embodiment, the roll press was performed at 25-50′C. In another embodiment, the roll press was performed at 50-100° C. In another embodiment, the roll press was performed at 100-150° C. In another embodiment, the roll press was performed at 100-180° C. In another embodiment, the roll press was performed at 50-75′C. In another embodiment, the roll press was performed at 75-100° C. In another embodiment, the roll press was performed at 100-125° C. In another embodiment, the roll press was performed at 125-150° C. In another embodiment, the roll press was performed at 125-180° C. In another embodiment, the roll press was performed at 50-120° C.

In one embodiment, the terms “a” or “an” as used herein, refer to at least one, or multiples of the indicated element, which may be present in any desired order of magnitude, to suit a particular application, as will be appreciated by the skilled artisan.

In some embodiments. The notation of “1 C”, “2 C”, “5 C” and “0.5 C” as disclosed for example in FIGS. 5A, 5B, 6) correspond to charge rates of cells (batteries; e.g. lithium-ion cells). For example, 1 C corresponds to 100% charging done at 1 hour; 0.5 C corresponds to 100% charging done at 2 hours; and 5 C corresponds to 100% charging done at 12 minutes (i.e. the actual time required for 100% charging is 60 minutes divided by the number left to the “C”; so the higher this number, the shorter the charging time).

The following examples are to be considered merely as illustrative and non-limiting in nature. It will be apparent to one skilled in the art to which the present invention pertains that many modifications, permutations, and variations may be made without departing from the scope of the invention.

### EXAMPLES

### Example 1

### A Hybrid of Alizarin and Single Wall Carbon Nano Tube (SWCNT)-Maintaining Conductivity Upon Stretch

20 mg of SWCNT (Tuball®) (from a 6 g batch milled for 2 minutes at 77 krpm, concentration of 0.5 g/i) and 20 mg alizarin were mixed in 40 mL isopropyl alcohol (IPA) in a bath-sonicated for 30 min. The dispersion was spray-coated on a 10×21 cm paper sheet in several layers where a heat gun was used to dry each layer. One side of a 20×3 cm commercial two-sided polyurethane gel elastomeric ribbon was taped on the length of the paper. The paper with the tape were passed through a laminator (hot press, at room temperature) in order to apply uniform pressure. Afterwards the tape was detached from the face of the paper sheet, and the CNT hybrid was fully transferred to it. The initial measured resistance from one end to another was 250Ω. The same tape then was stretched to ca. 30 cm, and the obtained measured resistance was 14 kΩ. The tape was additionally stretched to 123 cm and the measured resistance rose to 150 kΩ. Surface fiber alignment by swiping the tape with a finger pressure from end to end (while wearing nitrile rubber gloves) resulted in the 3-fold resistance decrease to 56 kΩ (Table 1). This behavior indicates the characteristic of the hybrid of this invention that maintains conductivity upon stretching the substrate (By changing the average distance between the CNTs, starting with 0.1 mg/cm² then the elastomer was stretched by 600%.).

TABLE 1
Resistance of elastomeric ribbon coated by
hybrid of this invention following stretch.

| Length of polyurethane gel | | |
|---|---|---|
| elastomeric ribbon | Resistance | |
| 20 cm (initial length) | 250 | Ω |
| 30 cm | 14 | kΩ |
| 123 cm | 150 | kΩ |
| 123 cm after surface fiber alignment | 56 | kΩ |

### Example 2

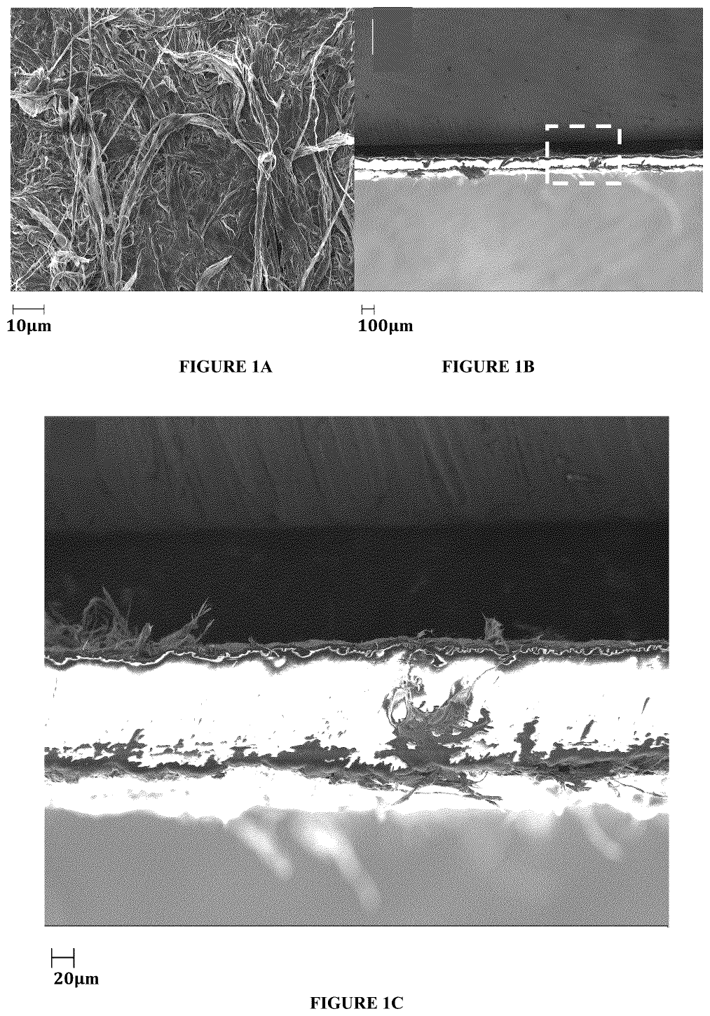

### A Hybrid of Alizarin and Single Wall Carbon Nano Tube (SWCNT) on a PE Substrate Via Transfer of Hybrid Coating Surface (FIGS. 1A-1C)

A paper sheet covered with Tuball® SWCNT-alizarin noncovalent hybrid obtained by the same method as described in Example 1. The paper sheet was folded in two along its width. A 5×5 cm piece of a commercial polyethylene t (PE) sheet (87.5±1 μm thick) was sandwiched between the CNT hybrid-covered face of the paper sandwiched again between two PET sheets (100 μm thick) and passed through a desktop laminator heated to 140° C. (hot roll press), it was repeated 10 times (see Table 2 for thickness of theCNT hybrid-coated paper after thermal laminator treatment). The CNT hybrid was completely transferred to the surfaces of the PE. The conductivity from end to end, after finger pressure strokes (with a gloved hand) all over the surface was measured to be in the range of 60-110Ω.

TABLE 2
Measured thicknesses of components
in the PE composite production.

| | | pEwith CNT |
|---|---|---|
| [μm] | PE sheet | hybrid |
| Sample 1 | 87.5 ± 1 μm | 107 ± 4 μm |
| Sample 2 | 87.5 ± 1 μm | 106 ± 3 μm |

The paper and the PE covered surfaces can be utilized as pressure sensors when two covered surfaces are laid facing each other. Pressure application on the sheets resulted in resistivity reduction (e.g. 10×5 cm area the resistance went from ca. 300Ω to ca. 250Ω and 215Ω when weights of 340 g and 1200 g were put on the device, respectively.

### Example 3

### A Hybrid of Purpurin and Multi Wall Carbon Nano Tube (MWCNT)

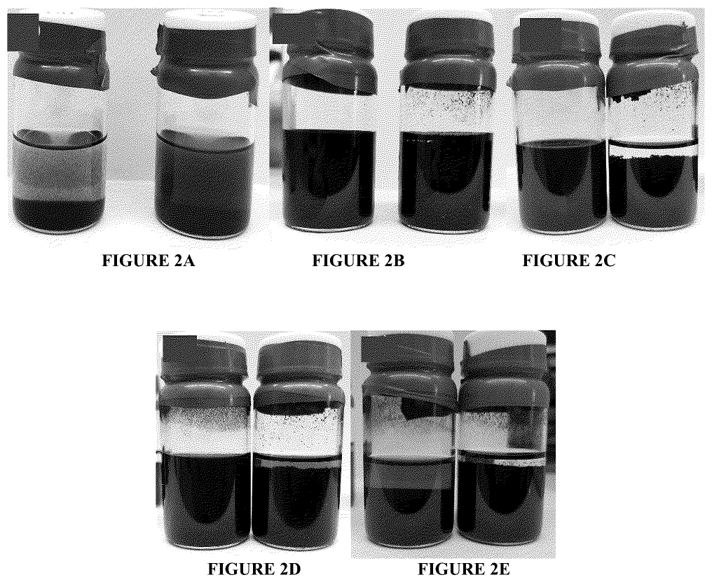

Purpurin and MWCNT (10-20 nm in diameter, 20-30 μm long, from Cheaptubes.com) hybrid noncovalent dispersions were prepared in different solvents (e.g. chloroform, tetrahydrofuran (THF), ethyl acetate (EA), acetone, IPA, acetonitrile canN), dimethyl sulfoxide (DMSO) and water (see FIGS. 2A-2E for comparison of MWCNT dispersion in various solvents). In a typical procedure, 12 mg of MWCNT, 6 mg of purpurin and 12 ml of one of the listed solvents were sonicated together for 15 min. The dispersion was stable for at least 14 hours. The MWCNT dispersion then was vacuum-filtrated and washed with the solvent until the washing solvent was clear. The received hybrid on the filter [buckypaper (BP)] was dried at ambient temperature and easily peeled off from the PVDF filter membrane. The obtained BP was highly hydrophilic (very small contact angle of a 100 μl water droplet) and can be used for example for water-oil separation or in desiccation

The obtained BP can be easily redispersed (to a concentration of at least 2 mg/ml) for e.g. in isopropanol or water by bath sonication of several minutes, enabling recyclability.

### Example 4

### A Hybrid of Purpurin and Single Wall Carbon Nano Tube (SWCNT)

Purpurin and SWCNT (Tuball® SWCNT) noncovalent hybrid dispersions were prepared. In a typical procedure 12 mg of SWCNT, 6 mg of purpurin and 12 ml of dichlorobenzene (DCB) were bath-sonicated for 30 min. Then 48 ml of DCB were added and sonicated for 15 min. The SWCNT dispersion was filtered through a syringe needle.

The dispersion was vacuum filtrated and washed with chloroform until the washings were colorless. The received hybrid on the filter (buckypaper, BP) was dried at ambient temperature and easily peeled off from the PVDF filter membrane. The obtained BP is hydrophilic.

### Example 5

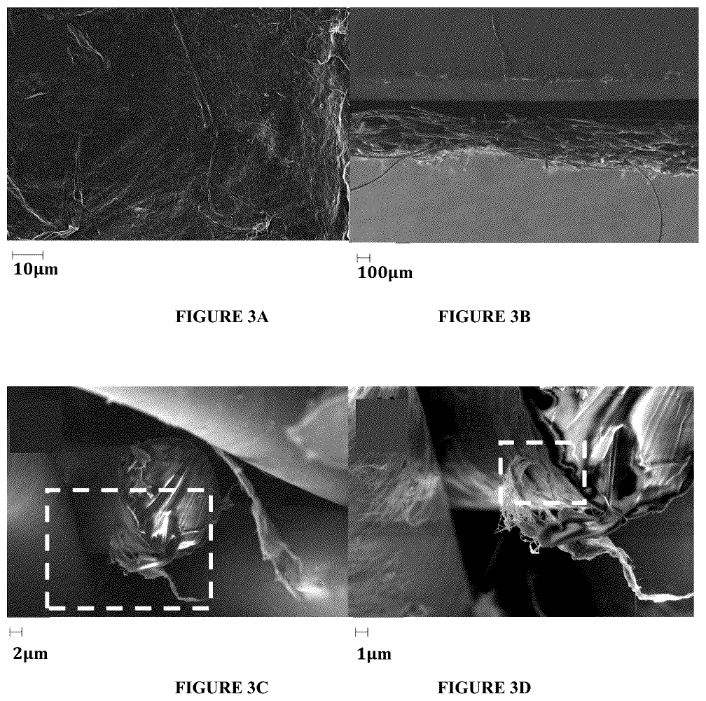

### Non-Woven Polypropylene Fabric Coated by Hybrid of this Invention (FIGS. 3A-3E)

A 10 cm diameter circle was cut out of a non-woven polypropylene (PP) fabric (40 g/m²). The PP circle (310 mg) was placed in vacuum filtration support with the same diameter, and 20 mg of SWCNT (Tuball™) with 20 mg alizarin in 40 ml of isopropyl alcohol was sprayed on it using a spray gun (0.8 mm nozzle at 0.5 bar pressure). After process the PP circle was placed in a 120° C. oven for ca. 5 min. The measured resistance of the diameter of the circle was ca. 400Ω (due to excess of alizarin). In the next step, the SWCNT hybrid covered PP circle was washed with IPA until the washings were practically colorless. The mass added to the PP circle measured after the washing is ca. 10 mg (˜3 w/w %). The PP circle was placed in a 120° C. oven for ca. 5 min. The measured resistance on the covered face on the diameter of the circle was ˜40Ω, while the non-covered face showed irregular conductivity at the range of 1-50*10³Ω. When the process is repeated on the other side, after the additional washing the total added mass is ca 30 mg (˜4.5 w/w %). The best double-sided sample had resistance on the diameter of the circle on both sided ˜15Ω.

### Example 6

### Single Wall Carbon Nanotubes (SWCN-s)-Kevlar ANF Hybrid

### ANFs Solution:

To 200 ml of Dimethyl sulfoxide (DMSO), 1 g of Kevlar (sewing thread, SGT.KNOTS) and 1.5 g KOH was added and stirred (350 rpm) for 7 days at r.t. to give dark red homogenous solution (5 mg/ml). The solution was further diluted with DMSO to lmg/ml concentration in order to obtain aramide nanofibers (ANF) solution.

### SWCNTs Grinding

1 g of SWCNTs (Tuball, Ocsial) were dry grinded using grinding machine (HSIANGTAI) for 10 min, cooling to r.t. after each 1 min of grindi SWCNT-Kevlar ANF hybrid

6 mg of the grinded SWCNTs were added to 12 ml of DMSO (0.5 mg/ml) in 20 ml vial and bath sonicated for 30 min. To the vial, ANF solution at different % was added and sonicated for another 15 min. The SWCNTs-ANF solution was then vacuum filtrated through PTFE membrane, forming a free-standing film, Buckypaper (BP), and washed with DMSO, DDW, and eventually with EtOH. After the washing, the filter paper with the BP was passed through lamination machine and then dried in oven (120° C.) for 5 min. The dry BP peeled easily from the filter paper.

Table 3 presents the mechanical properties and electrical conductivity of SWCNTs BP.

TABLE 3
Mechanical properties and electrical conductivity of
SWCNTs BP with 50% ANF by weight and without ANFs.

| | | Ultimate | | | |
|---|---|---|---|---|---|
| | Young's | Tensile | Elongation | | |
| | Modulus | Strength | at break | Toughness | Conductivity |
| Sample | (GPa) | (MPa) | (%) | (MPa) | (S/cm) |
| SWCNTs with | 0.4 ± 0.075 | 17 ± 2.3 | 5.8 ± 1.2 | 0.52 ± 0.2 | 941 ± 67 |
| 50% ANFs | | | | | |
| SWCNTs | 0.18 ± 0.05 | 3.94 ± 1.33 | 3.01 ± 0.9 | 0.07 ± 0.04 | 1718 ± 166 |
| without ANFs | | | | | |

### Example 7

### Electrode from Acetone Dispersion of SWCNT/Alizarin and NMC811

12 mg of SWCNT were weighed into a 20 mL scintillation glass vial with 0.84 mg alizarin in 330 μL acetone (6.5 w/w %); and 9.7 mL of acetone (analytical reagent grade) were added and the vial was sealed with a PTFE lined cap. The vial was sonicated in a sonication bath (120W pulsed sequence at 20° C.) for 30 min. 120 mg of NMC811 (LiNi_{0.8}Co_{0.1}Mn_{0.1}O₂) were weighed in a 100 mL glass bottle and dispersed in 8 mL of acetone with 15 sec. sonication. The CNT dispersion was transferred onto the NMC dispersion. The leftovers in the vial were washed with additional 4 mL of acetone into the bottle. The mutual mixture was sonicated for additional 10 min in a sonication bath (120W pulsed sequence at 20° C.). The dispersion was vacuum filtered over a filter paper and washed twice with 4 mL of tech acetone. The obtained retentate with the filter paper were put into a roll press and then kept for 5 minutes in an oven at 120° C. The obtained self-standing and flexible electrode (39 mm in diameter) was easily separated from the filter paper. Average two point resistance around the diameter was measured as 3.1±0.1Ω. The average thickness of the electrode was 87±4 μm.

### Example 8

### Electrode from Isopropanol Dispersion of SWCNT/Alizarin and NMC811

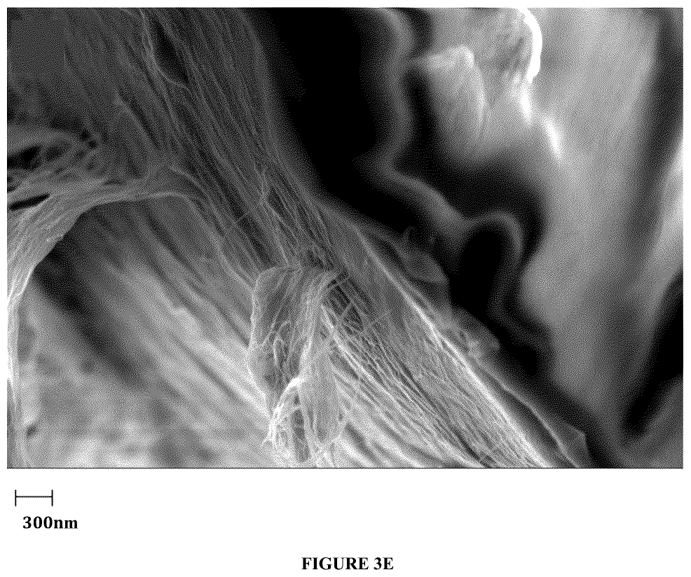

12 mg of SWCNT were weighed into a 20 mL scintillation glass vial with 0.84 mg alizarin in 330 μL acetone (6.5 w/w %); and 9.7 mL of isopropanol (analytical reagent grade) were added and the vial was sealed with a PTFE lined cap. The vial was sonicated in a sonication bath (120W pulsed sequence at 20° C.) for 30 min. 120 mg of NMC811 (LiNi_{0.8}Co_{0.1}Mn_{0.1}O₂) were weighed in a 100 mL glass bottle and dispersed in 8 mL of acetone with 15 sec. sonication. The CNT dispersion was transferred onto the NMC dispersion. The leftovers in the vial were washed with additional 4 mL of acetone into the bottle. The mutual mixture was sonicated for additional 10 min in a sonication bath (120W pulsed sequence at 20° C.). The dispersion was vacuum filtered over a filter paper and washed twice with 4 mL of tech acetone. The obtained retentate with the filter paper were put into a roll press and then kept for 5 minutes in an oven at 120° C. The obtained self-standing and flexible electrode (39 mm in diameter) was easily separated from the filter paper. Average two point resistance around the diameter was measured as 3.0±0.2Ω. The average thickness of the electrode was 88±7 μm. The electrode was further characterized by SEM (FIGS. 4A-4D).

### Example 9

### Rate Performance Study and Stability Study of Examples 7-8 Electrodes

To evaluate the rate performance of the developed cathode films (electrodes of Examples 7-8), 2032 coin cells (usually, a lithium coin or “button” cell battery that is 20 mm diameter×3.2 mm thickness) were constructed with Li metal serving as the anode. Assembly of these cells took place in an argon-filled glove box to prevent contamination. The process involved careful placement of the cathode (one of the electrodes of Examples 7-8, or prepared similarly with slightly altered amounts of materials), anode (Li metal), and borosilicate separator, followed by the introduction of 200 μL of 1M LP30 electrolyte (1M LiPF₆ in a 50:50 EC:DMC). Post-assembly, the coin cells were subjected to a detailed testing phase (FIGS. 5A-5B and FIGS. 6-7). In this phase, the cells were first rested at OCV (open circuit voltage) for 2 hours, then they underwent cycling at progressively increasing current densities, ranging from 0.1 C up to 5 C. At each of these current densities, both charge and discharge capacities of the cells were recorded. In the stability study (FIG. 7), the coin cells were tested at a constant 1 C rate for both charging and discharging.

### Discussion

FIGS. 5A-5B showcase the rate performance of various free-standing NMC (lithium nickel manganese cobalt oxide)-CNT electrodes, which were fabricated using two distinct solvents: isopropyl alcohol and acetone. Additionally, for the purpose of comparison, a traditional Al-foil (a charge/current collector) based NMC electrode was also produced, without CNT or alizarin (without an hybrid), as a reference. The reference NMC electrodes include NMC with a binder and carbon particles coated on Al foil. The results depicted in FIG. 5A indicate that the NMC-CNT free-standing cathodes generally performed on par with the standard Al-foil based NMC electrode up to a 1 C rate. At higher rates of 2 C and 5 C, the Al-foil based NMC cathodes showed slightly better performance, probably as they are much thinner, which may play a critical role in its rate performance. The Coulombic efficiency remained consistently around 100% for both the free-standing NMC-CNT and the Al-foil based NMC electrodes.

A key benefit of utilizing free-standing electrodes of Examples 7-8 is leveraging the higher material loading, as illustrated in FIG. 5A. The capacity values presented in the rate performance studies (FIG. 5A) were calculated by normalizing against the active NMC mass in each electrode. Given that free-standing electrodes incorporate a greater amount of active material, they are capable of delivering significantly higher overall energy compared to standard Al-foil based NMC electrodes. This advantage becomes apparent when capacity is normalized by the electrode's surface area, as shown in FIG. 6. The data reveal a marked improvement in capacity for the free-standing electrodes, which notably outperform the Al-foil based electrodes even at a 5 C rate. It's crucial to acknowledge that the NMC mass and the overall electrode thickness in free-standing electrodes are adjustable, and will be used to enhance the battery performance.

In addition, the above discussed great performance is further emphasized when considering that lithium-ion cells of said free-standing electrodes do not include charge/current collectors and binders. Hence, these cells are advantageous also in regards to, ease of preparation, costs and pathway towards commercialization of said cells, due to the lack of said components and the actual free-standing nature of the electrodes. Therefore, it was unexpected that said free-standing electrodes would perform as they did in comparison to regular non-free standing electrodes, as said charge/current collectors and binders are usually advantageous and required in regards to electrical and mechanical (robustness/physical stability) properties of the cells.

### Example 10

Electrode from Isopropanol Dispersion of SWCNT/Alizarin and Graphite.

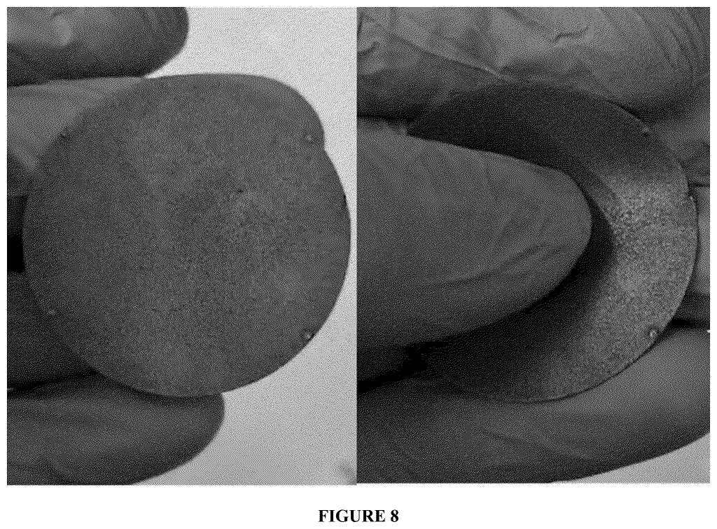

12 mg of SWCNT were weighed into a 20 mL scintillation glass vial with 0.84 mg alizarin in 330 μL acetone (6.5 w/w %); and 9.7 mL IPA (isopropanol) were added and the vial was sealed with a PTFE lined cap. The vial was sonicated in a sonication bath (120W pulsed sequence at 20° C.) for 30 min. 228 mg of graphite (5-10 μm) were weighed in a 100 glass bottle and dispersed in 8 mL of IPA. The graphite dispersion was added onto the SWCNT dispersion and mixed vigorously. The mutual SWCNT-graphite dispersion was diluted to a total volume of 40 mL with IPA and was sonicated in a sonication bath (120W pulsed sequence at 20° C.) for 10 min. The sonicated dispersion was filtered over a filter paper and washed twice with 4 mL of acetone. The obtained retentate with the filter paper were put into a press and then kept for 10 minutes in an oven at 120° C. The obtained electrode (39 mm in diameter) was easily separated from the paper. The electrode was flexible and tough. Obtained thickness was 296±5 μm. FIG. 8 shows the provided electrode.

It is appreciated by persons skilled in the art that the present invention is not limited by what has been particularly shown and described hereinabove. Rather the scope of the present invention includes both combinations and sub-combinations of various features described hereinabove as well as variations and modifications. Therefore, the invention is not to be constructed as restricted to the particularly described embodiments, and the scope and concept of the invention will be more readily understood by references to the claims, which follow.

What is claimed is:

1. An electrode comprising a noncovalent hybrid, wherein the hybrid comprises carbon nanotubes and anthraquinone or derivative thereof.

2. The electrode of claim 1, further comprising an active material and optionally a binder and/or a charge collector.

3. The electrode of claim 2, wherein the anthraquinone derivative is dihydroxy or trihydroxy anthraquinone.

4. The electrode of claim 2, wherein the electrode is a cathode and the active material is a cathode active material comprising a lithium based material.

5. The electrode of claim 4, wherein the lithium based material comprises lithium iron phosphate, lithium cobalt oxide, lithium manganese oxide, lithium nickel manganese cobalt oxide, lithium nickel cobalt aluminum oxide, lithium nickel oxide, lithium iron manganese phosphate, lithium nickel manganese oxide, lithium manganese phosphate, lithium cobalt phosphate, lithium nickel cobalt phosphate, lithium manganese iron cobalt phosphate, lithium iron fluorosulfate or any combination thereof.

6. The electrode of claim 5, wherein the lithium based material comprises lithium nickel manganese cobalt oxide.

7. The electrode of claim 2, wherein the electrode is an anode and the active material is an anode active material comprising graphite, soft/amorphous carbon, hard carbon, graphene, lithium titanium oxide, Si, Sn, Sb, Al, Ge, Mg or any combination thereof.

8. The electrode of claim 7, wherein the anode active material comprises graphite.

9. The electrode of claim 2, wherein the electrode is circular and the average two point resistance around the diameter of the electrode is between 2 and 4Ω.

10. The electrode of claim 2, wherein the average thickness of the electrode is between 10 and 400 μm.

11. A lithium-ion cell comprising an anode, a cathode, an electrolyte, and a separator wherein at least one of the anode or the cathode comprises a noncovalent hybrid and an active material, wherein the noncovalent hybrid comprises carbon nanotubes and anthraquinone or derivative thereof.

12. The lithium-ion cell of claim 11, wherein both the anode and cathode comprise the noncovalent hybrid and an active material.

13. The lithium-ion cell of claim 12, wherein the anode comprises an anode active material comprising graphite, soft/amorphous carbon, hard carbon, graphene, lithium titanium oxide, Si, Sn, Sb, Al, Ge, Mg or any combination thereof.

14. The lithium-ion cell of claim 12, wherein the cathode comprises a cathode active material comprising a lithium based material.

15. The lithium-ion cell of claim 14, wherein the lithium based material comprises lithium iron phosphate, lithium cobalt oxide, lithium manganese oxide, lithium nickel manganese cobalt oxide, lithium nickel cobalt aluminum oxide, lithium nickel oxide, lithium iron manganese phosphate, lithium nickel manganese oxide, lithium manganese phosphate, lithium cobalt phosphate, lithium nickel cobalt phosphate, lithium manganese iron cobalt phosphate, lithium iron fluorosulfate or any combination thereof.

16. The lithium-ion cell of claim 11, wherein the anode comprises the noncovalent hybrid, an anode active material and optionally binder and/or a charge collector, and the cathode comprises a cathode active material, conductive material and optionally a binder and/or charge collector.

17. The lithium-ion cell of claim 16, wherein the anode active material comprises graphite, soft/amorphous carbon, hard carbon, graphene, lithium titanium oxide, Si, Sn, Sb, Al, Ge, Mg or any combination thereof.

18. The lithium-ion cell of claim 16, wherein the cathode active material comprises a lithium based material.

19. The lithium-ion cell of claim 18, wherein the lithium based material comprises lithium iron phosphate, lithium cobalt oxide, lithium manganese oxide, lithium nickel manganese cobalt oxide, lithium nickel cobalt aluminum oxide, lithium nickel oxide, lithium iron manganese phosphate, lithium nickel manganese oxide, lithium manganese phosphate, lithium cobalt phosphate, lithium nickel cobalt phosphate, lithium manganese iron cobalt phosphate, lithium iron fluorosulfate or any combination thereof.

20. The lithium-ion cell of claim 11, wherein the cathode comprises the noncovalent hybrid, a cathode active material and optionally a binder and/or a charge collector, and the anode comprises an anode active material, a conductive material and optionally a binder and/or charge collector.

21. The lithium-ion cell of claim 20, wherein the anode active material comprises graphite, soft/amorphous carbon, hard carbon, graphene, lithium titanium oxide, Si, Sn, Sb, Al, Ge, Mg or any combination thereof.

22. The lithium-ion cell of claim 20, wherein the cathode active material comprises a lithium based material.

23. The lithium-ion cell of claim 22, wherein the lithium based material comprises lithium iron phosphate, lithium cobalt oxide, lithium manganese oxide, lithium nickel manganese cobalt oxide, lithium nickel cobalt aluminum oxide, lithium nickel oxide, lithium iron manganese phosphate, lithium nickel manganese oxide, lithium manganese phosphate, lithium cobalt phosphate, lithium nickel cobalt phosphate, lithium manganese iron cobalt phosphate, lithium iron fluorosulfate or any combination thereof.

24. A process of preparing an electrode according to claim 2, comprising:
sonicating a solution comprising the carbon nanotubes, anthraquinone or derivative thereof and a first solvent;
adding the sonicated solution to dispersion of the active material dispersed in a second solvent, and sonicating the resulting mixture;
filtering the resulting sonicated mixture comprising the active material, carbon nanotubes and anthraquinone or derivative thereof;
putting the obtained retentate in a roll press; and
separating the provided film from roll press to obtain the electrode.

25. The process of claim 24, further comprising covering the obtained electrode with a charge collector foil.

26. The process of claim 25, wherein the foil comprises aluminum for a cathode or copper for an anode.
